(19) United States
(12) Patent Application Publication
(10) Pub. No.: US 2009/0086512 A1
(43) Pub. Date: Apr. 2, 2009

(54) Driving a primary-side switch and a secondary-side rectifier element in a switching converter

(75) Inventors: Marc Fahlenkamp, Geretsried (DE); Harald Zoellinger, Gilching (DE); Gerald Deboy, Klagenfurt (AT); Lutz Goergens, Villach (AT)

Correspondence Address: BANNER & WITCOFF, LTD.;Attorneys for client 007052, 1100 13th STREET, N.W., SUITE 1200, WASHINGTON, DC, 20005-4051, US

(73) Assignee: INFINEON TECHNOLOGIES AUSTRIA AG, Villach (AT)

(21) Appl. No.: 11/864,024

(22) Filed: Sep. 28, 2007

(51) Int. Cl. H02M 3/335

(52) U.S. Cl. 363/21.06

(57) ABSTRACT

An apparatus, comprising a transformer comprising a first winding and a second winding; a first switch coupled to the first winding and configured to alternate between an off state and an on state in response to a pulsed first signal; a rectifier coupled to the second winding and configured to alternate between an off state and an on state in response to a pulsed second signal; and a drive circuit configured to generate the first and second signals such that the first switch and the rectifier are switched to the on state in a temporally offset relation with each other.

### TECHNICAL BACKGROUND

It is known to provide a transformer having a primary winding and a secondary winding in switching converters, the transformer serving to transfer energy from a primary side to a secondary side of the switching converter. In order to control the power consumption, at least one switch arranged on the primary side is present in such switching converters, the switch being connected to the primary winding and being driven in pulse-width-modulated fashion in order to control the power consumption. On the secondary side, such switching converters have a rectifier arrangement with at least one rectifier element. In this case, the polarity of a voltage across the rectifier element is dependent on the switching state of the primary-side switch.

The secondary-side rectifier element can be a diode. In order to reduce the power loss, instead of a diode it is also possible to use switchable rectifier elements, such as a metal-oxide-semiconductor field-effect transistor (MOSFET), for example, which has an integrated diode (body diode). The power loss can be reduced in this case by virtue of the MOSFET being driven in the conducting state during those operating states in which the integrated diode is forward-biased, such that a conducting channel (MOS channel) forms in the MOSFET in parallel with the forward-biased diode. A current then flows principally via the MOS channel, which has a lower on resistance than the forward-biased diode. This results in a reduction of the power loss. The MOS channel is turned off in timely fashion before a reversal (polarity reversal) of the voltage present across the rectifier element occurs, upon which the rectifier element is intended to turn off.

After the turn-off of the MOS channel and before the polarity reversal of the voltage present across the rectifier element, a current then still flows via the integrated diode of the MOSFET. After the turn-off of the MOS channel, upon polarity reversal of the voltage, i.e. upon a commutation of the integrated diode, overvoltage spikes can occur which may be considerably higher than the voltage subsequently present across the rectifier element. In this case, the MOSFET used as rectifier element should be dimensioned in such a way that it is not destroyed by these overvoltage spikes that occur. Therefore, the MOSFET used should be dimensioned suitably with regard to the overvoltage spikes that occur, which has the effect that MOSFETs having a higher dielectric strength (higher voltage class) than is necessary when taking account of the voltages present in the static case should be used.

Therefore, there is a need to reduce the voltage spikes that occur upon the commutation of a MOSFET used as rectifier element.

### SUMMARY

Aspects as described herein are directed to, for example, an apparatus, comprising a transformer comprising a first winding and a second winding; a first switch coupled to the first winding and configured to alternate between an off state and an on state in response to a pulsed first signal; a rectifier coupled to the second winding and configured to alternate between an off state and an on state in response to a pulsed second signal; and a drive circuit configured to generate the first and second signals such that the first switch and the rectifier are switched to the on state in a temporally offset relation with each other. Related methods are also described.

These and other aspects are described in the Detailed Description in connection with various illustrative embodiments.

### BRIEF DESCRIPTION OF THE FIGURES

Examples of aspects of the present invention are explained in more detail below with reference to figures. The figures serve in each case for elucidating the basic principle of various aspects of the invention and therefore show details of only certain circuit components for understanding the basic principle. In the figures, unless indicated otherwise, identical reference symbols designate identical components and circuit blocks with the same function and meaning.

Various aspects as described herein are based on the insight that a time duration between a blocking driving of the rectifier element and the beginning of a commutation of the rectifier element influences overvoltage spikes. In this case, the greater the overvoltage spikes, the longer the time duration between the blocking driving of the rectifier element and the beginning of the commutation of the rectifier element. By adaptively setting the time delay, the voltage spikes may be reduced.

FIG. 1 shows an illustrative switching converter which is embodied as a forward converter and which has a half-bridge topology on the primary side and a current doubler topology on the secondary side.

FIG. 2 illustrates an example of functioning of the switching converter illustrated in FIG. 1 on the basis of temporal profiles of selected signals.

FIG. 3 illustrates in detail an example of temporal coordination between drive signals of primary-side switches and of secondary-side rectifier elements in the switching converter illustrated in FIG. 1.

FIG. 4 shows in detail an example of the voltage and current profile of a freewheeling element during a commutation phase.

FIG. 5 shows an example of a drive circuit for generating primary-side and secondary-side drive signals which are temporally offset depending on a delay signal.

FIG. 6 shows a first example of a circuit for generating the delay signal.

FIG. 7 shows a second example of a circuit for generating the delay signal.

FIG. 8 shows an example of a pulse width modulator of the drive circuit in accordance with FIG. 5.

FIG. 9 illustrates an example of the functioning of the pulse width modulator in accordance with FIG. 8 on the basis of temporal signal profiles.

FIG. 10 shows an example of a coupling circuit of the drive circuit illustrated in FIG. 5.

FIG. 11 illustrates an example of the functioning of the coupling circuit in accordance with FIG. 10 on the basis of temporal signal profiles.

FIG. 12 shows an example of a secondary-side switching converter topology in which a secondary winding of a transformer has a center tap (center tap topology).

FIG. 13 illustrates an example of the generation of the primary-side and secondary-side drive signals for a switching converter having the secondary-side topology illustrated in FIG. 12.

FIG. 14 shows an excerpt from an illustrative drive circuit for generating the drive signals illustrated in FIG. 13.

FIG. 15 shows an illustrative switching converter realized as a forward converter with a single primary-side switch—formed as a transistor (single transistor forward converter (STF)).

FIG. 16 illustrates an example of the functioning of the switching converter illustrated in FIG. 15 on the basis of temporal signal profiles.

FIG. 17 shows an example of a drive circuit for generating primary-side and secondary-side drive signals for the switching converter illustrated in FIG. 15.

FIG. 18 illustrates an example of the use of a MOSFET as a rectifier element in a switching converter in accordance with FIG. 15.

FIG. 19 illustrates an example of the functioning of the rectifier element formed as a MOSFET in accordance with FIG. 18 on the basis of temporal signal profiles.

FIG. 20 shows an example of a circuit for generating a drive signal for the rectifier element in accordance with FIG. 18.

FIG. 21 shows an example of a switching converter realized as a forward converter with two switches—formed as transistors—arranged on the primary side (two transistor forward converter (TTF)).

FIG. 22 shows an illustrative switching converter having two transistor forward converters which are connected to common output terminals and which are operated in temporally offset fashion (interleaved two transistor forward converter (ITTF)).

FIG. 23 shows an alternative example of a secondary-side topology for the switching converter illustrated in FIG. 22.

FIG. 24 shows an illustrative switching converter having a switch and an active clamping circuit on the primary side (active clamp forward converter).

FIG. 25 shows an illustrative switching converter which has a full-bridge topology on the primary side and a current doubler topology on the primary side and which is embodied as a forward converter with zero voltage operation (phase shift zero voltage switching (ZVS)).

FIG. 26 shows a basic circuit diagram of an illustrative power factor correction circuit.

### DETAILED DESCRIPTION

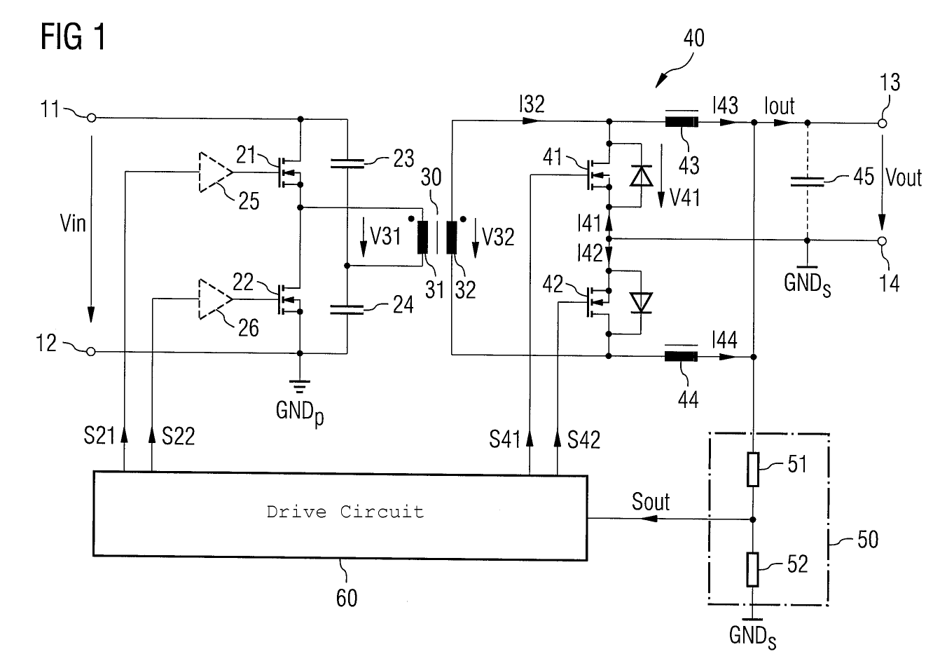

FIG. 1 shows an example of a switching converter which is embodied as a forward converter and which has a half-bridge topology on the primary side and a current doubler topology on the secondary side. The switching converter has a transformer 30 with a primary winding 31 and a secondary winding 32 inductively coupled to the primary winding 31. These windings 31, 32 have the same winding sense in a forward converter. Circuit components of the switching converter which are directly or indirectly connected to the primary winding 31 are referred to hereinafter as primary-side circuit components, and circuit components which are directly or indirectly connected to the secondary winding 32 are referred to hereinafter as secondary-side circuit components of the switching converter.

The transformer 30 forms a potential barrier for signals, i.e. voltages and currents, which occur on the primary side and on the secondary side in the switching converter. Voltages occurring on the primary side in the switch are in this case referenced to a primary-side reference-ground potential GNDP, and voltages occurring on the secondary side are referenced to secondary-side reference-ground potential GNDₛ.

The switching converter has on the primary side input terminals 11, 12 for applying an input voltage Vin, which is usually a DC voltage, and on the secondary side output terminals 13, 14 for providing an output voltage Vout for a load (not illustrated). The basic principle of the forward converter illustrated in FIG. 1 consists in generating, from the input voltage Vin present at the input terminals 11, 12, a clocked voltage, such as a pulse-width-modulated voltage V31, having changing polarity, which is present across the primary winding, and in rectifying a resultant clocked voltage, such as a pulse-width-modulated voltage V32, present across the secondary winding 32, in order thereby to generate the output voltage Vout. For this purpose, the switching converter illustrated has on the primary side a half-bridge with two switches 21, 22, which are connected in series with one another between the input terminals 11, 12. A center tap of the half-bridge, that is to say a node common to the two switches 21, 22, is in this case connected to a first connection of the primary winding 31. A second connection of the primary winding 31 is connected to a center tap of a capacitive voltage divider having two capacitive storage elements 23, 24—for example capacitors—connected in series with one another between the input terminals 11, 12. The two capacitive storage elements 23, 24 have for example in each case an identical capacitance. An electrical potential at the center tap of the capacitive voltage divider then corresponds to half the input voltage Vin. The switches 21, 22 of the half-bridge are embodied for example as semiconductor switches, such as MOSFETs. In the example in accordance with FIG. 1, these two switches 21, 22 are n-channel MOSFETs.

A drive circuit 60 is provided for driving the half-bridge switches 21, 22, which drive circuit generates a first drive signal S21 for a first half-bridge switch 21 from the half-bridge switches and a second drive signal S22 for a second half-bridge switch 22 from the half-bridge switches. The drive signals S21, S22 provided by the drive circuit 60 are logic signals, for example, which can be converted to signal levels suitable for driving the switches 21, 22 by driver circuits 25, 26 respectively connected upstream of the half-bridge switches 21, 22. The two switches 21, 22 are driven in clocked fashion by the drive signals S21, S22, to be precise in such a way that the two switches 21, 22 are driven in the conducting state in temporally offset fashion with respect to one another and are in this example never in the conducting state simultaneously. A “clocked” driving of a switch should be understood hereinafter to mean any desired driving by means of which the switch is switched on for a switched-on duration and is subsequently switched off for a switched-off duration. The clocked driving may be for example a pulse-width-modulated driving in which the duration of the switched-on duration and/or of the switched-off duration is variable. Even though the driving of the switches is a pulse-width-modulated driving in some of the examples explained below, the invention is not, of course, restricted to such a pulse-width-modulated driving, but rather can be applied to any clocked driving.

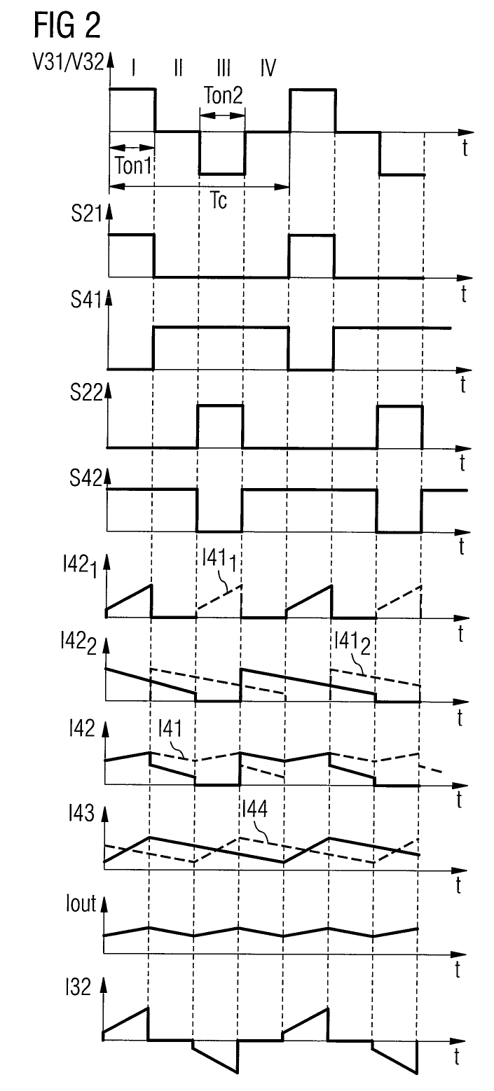

A drive cycle of the switching converter illustrated in FIG. 1, during which each of the primary-side switches 21, 22 is driven in the conducting state once, comprises four different operating phases or operating states, which are designated by I to IV hereinafter. These four different operating phases are explained below with reference to FIG. 2, which illustrates temporal profiles of the first and second drive signals S21, S22 and also of the voltage V31 across the primary winding 31 and the voltage V32 across the secondary winding 32. For the explanation below it should be assumed here that the switches 21, 22 are in the conducting state or are switched on in the case of an upper signal level (high level) of the respective drive signal S21, S22 and are in the blocking state or are switched off in the case of a lower signal level (low level) of the respective drive signal.

In a first operating phase I, the first switch 21 is in the conducting state and the second switch 22 is in the blocking state. In this case, a voltage V31 corresponding to half the input voltage Vin is present across the primary winding 31. In this case, the voltage V32 present across the secondary winding 32 is proportional to the primary voltage V31 and is related to the primary voltage V31 by way of the transformation ratio or turns ratio of the transformer 30. Merely for the sake of simplified illustration, it is assumed for the illustration in FIG. 2 that the signal levels of the voltages V31, V32 are identical in each case. During a second operating phase II, both switches are in the blocking state. The primary voltage V31 and the secondary voltage V32 are zero in this case. During a subsequent third operating phase III, the first switch 21 is in the blocking state, while the second switch 22 is in the conducting state. The primary voltage V31 then has, in comparison with the voltage during the first operating phase I, an opposite sign with a magnitude corresponding to half the input voltage. Afterward, during a fourth operating phase IV, both switches 21, 22 are open again until a new drive cycle begins with conducting driving of the first switch 21.

The duration Tc of a drive cycle is for example fixedly predetermined. The power consumption of the switching converter, that is to say the power which the switching converter takes up via the input terminals 11, 12 on the primary side and outputs to the load via the output terminals 13, 14 on the secondary side, can in this case be controlled by way of the switched-on durations Ton1, Ton2 of the switches 21, 22 in a manner yet to be explained, in which case the switched-on durations can each have the same length. In the example illustrated, the clocked drive signals S21, S22 are pulse-width-modulated signals, that is to say signals whose switched-on duration is variable during a drive cycle. A duty cycle of the two switches 21, 22 corresponds to the ratio between the respective switched-on duration Ton1 or Ton2 and the total duration Tc of a drive cycle. The duty cycle of a switch may lie between 30% and 40%, for example.

The two switches 21, 22 can be operated symmetrically in such a way that the voltage present at the tap of the capacitive voltage divider 23, 24—as mentioned above—corresponds to half the input voltage Vin. The primary voltage V31 established is then identical during the first and third operating phases I, III. The two switches 21, 22 can furthermore also be operated asymmetrically in such a way that the voltage present at the tap of the capacitive voltage divider 23, 24 is not equal to half the input voltage Vin. The primary voltage V31 established is then different during the first and third operating phases I, III. If the magnitude of the difference between the voltage at the tap of the capacitive voltage divider 23, 24 and half the input voltage Vin is considered, then the difference between the primary voltages V31 during the first and third operating phases corresponds to twice the aforementioned difference.

For rectifying the voltage V32 present across the secondary winding 32, the switching converter illustrated in FIG. 1 has on the secondary side a rectifier arrangement 40 with a first and a second inductive storage element 43, 44 which are realized as storage inductors, for example. In this case, the first storage inductor 43 is connected between a first connection of the secondary winding 32 and the first output terminal 13, and the second storage inductor 44 is connected between a second connection of the secondary winding 32 and the first output terminal 13. An output capacitor 45 of the rectifier arrangement 40 is connected between the output terminals 13, 14.

The rectifier arrangement arranged on the secondary side additionally has two rectifier elements 41, 42, of which a first 41 is connected in parallel with the series circuit comprising the first storage inductor 43 and the output capacitor 45 and of which a second 42 is connected in parallel with the series circuit comprising the second storage inductor 44 and the output capacitor 45. The two rectifier elements 41, 42, which are also referred to hereinafter as freewheeling elements, have in each case two functions in the circuit topology illustrated in FIG. 1, which is also referred to as current doubler topology, the functions being explained below: the second freewheeling element 42 enables a current flow via the storage inductor 43 and the output capacitor 45 during the first operating phase I, during which a positive secondary voltage V32 is present. During this first operating phase I, which is also referred to hereinafter as a first charging phase, a closed electric circuit is present which leads from the secondary winding 32 via the storage inductor 43, the output capacitor 45 and the second freewheeling element 42. During this first charging phase, electrical energy is stored in the first storage inductor 43. The first freewheeling element 41 enables a current flow from the secondary winding 32 via the second storage inductor 44 and the output capacitor 45 during the third operating phase III, which is referred to hereinafter as second charging phase. During this second charging phase, a closed electric circuit is present which leads from the secondary winding 32 via the storage inductor 44, the output capacitor 45 and the first freewheeling element 41 back to the secondary winding 32. During this second charging phase, electrical energy is stored in the second storage inductor 44. After the first charging phase, the first freewheeling element 41 enables a freewheeling current to flow via the storage inductor 43 and the output capacitor 45 and thereby prevents the occurrence of overvoltages due to the energy previously stored in the first storage inductor 43. Correspondingly, the second freewheeling element 42, after the conclusion of the second charging phase, enables a freewheeling current to flow from the second storage inductor 44 via the output capacitor 45.

In the case of the secondary topology illustrated in FIG. 1, currents I41, I42 through the two freewheeling elements 41, 42 comprise two current components in each case. A first current component I41₁, I42₁ is present only during the respective charging phases. This current component, which is illustrated in FIG. 2 as a solid line for the first current component I42₁ of the second freewheeling element 42 and as a dashed line for the first current component I41₁ of the first freewheeling element 41, in each case rises during the charging phases. Second current component I41₂, I42₂ results from the freewheeling currents that flow in each case after the conclusion of the charging phases. In this case, the second current component I42₂ of the second freewheeling element 42 results from the freewheeling current of the first storage inductor 44, while the second current component I41₂ of the first freewheeling element 41 results from the freewheeling current of the first storage inductor 43. These second current components I41₂, I42₂ are likewise illustrated in FIG. 2. Proceeding from the current level reached by the currents through the storage inductors 43, 44 during the respective charging phase, the currents through the storage inductors 43, 44 and hence the second current components I41₂, I42₂ fall over time during the freewheeling phases. Referring to FIG. 2, the freewheeling phase of the first freewheeling element 41 in this case comprises the operating phases II, III and IV, while the freewheeling phase of the second freewheeling element 42 comprises the operating phases IV, I and II.

In order to afford a better understanding, FIG. 2 also illustrates temporal profiles of the currents I41, I42 flowing overall through the freewheeling elements, of the currents I43, I44 flowing overall through the storage inductors 43, 44, of the output current Iout of the switching converter and also of a current I32 flowing through the secondary winding 32.

In the switching converter illustrated in FIG. 1, the freewheeling elements 41, 42 are realized in each case as a MOSFET—for example as an n-channel MOSFET—and have an integrated diode, which is referred to as a body diode. In order to afford a better understanding, a circuit symbol of the body diode is likewise illustrated in FIG. 1. The body diode is connected in parallel with the load path or drain-source path of the MOSFET. In the case of an n-channel MOSFET, the forward direction of the body diode runs from source to drain. In this case, the MOSFETs 41, 42 used as freewheeling elements are connected up in such a way that the charging and freewheeling phases explained with reference to FIG. 2 could be provided solely by the integrated body diodes, i.e. without the MOSFETs 41, 42 being driven in the conducting state. In this case, the first MOSFET 41 is connected up in such a way that its body diode lies in the forward direction between the second connecting terminal 14 and the first storage inductor 43. The source connection of the first MOSFET 41 is therefore connected to the second output terminal 14, while its drain connection is connected to the node common to the secondary winding 32 and the first storage inductor 43. The second MOSFET 43 is connected up in such a way that its body diode is connected in the forward direction between the second connecting terminal 14 and the second storage inductor 44. The source connection of the MOSFET 42 is therefore connected to the second output terminal 14, while its drain connection is connected to a node common to the second storage inductor 44 and the secondary winding 32.

In order to reduce the power loss, in the switching converter illustrated in FIG. 1, provision is made for driving the respective MOSFET 41, 42 in the conducting state during those operating states during which the body diodes are forward-biased. The conducting channel that arises in the component in this case, the channel being referred to hereinafter as MOS channel, has a lower on resistance than the body diode, such that the currents I41, I42 flowing through the MOSFETs 41, 42 flow via the MOS channel, which results in a reduced power loss.

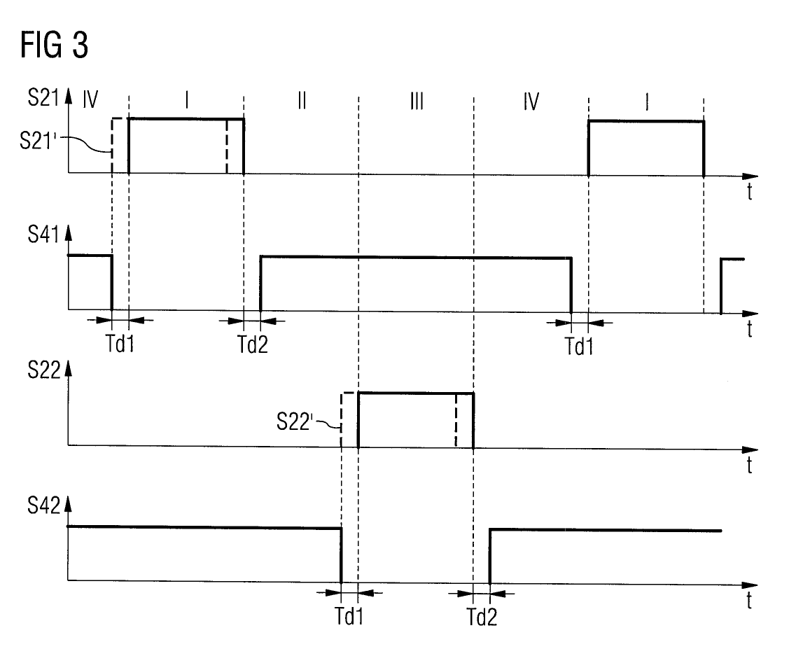

Drive signals S41, S42 for the two MOSFETs 41, 42 used as freewheeling elements are likewise provided by the drive circuit 60. The basic temporal profile of the drive signals S41, S42 is likewise illustrated in FIG. 2, in which case it is assumed for elucidation purposes that the MOSFETs 41, 42 in each case are in the conducting state in the case of a high level of the respective drive signal S41, S42 and are in the blocking state in the case of a low level of the respective drive signal S41, S42. Ideally, the two MOSFETs 41, 42 are in each case driven in the conducting state during the entire time duration during which the associated body diode is forward-biased. These are the operating phases II, III and IV in the case of the first MOSFET 41. They are the operating phases IV, I and II in the case of the second MOSFET 42. In order, however, to reliably prevent a short circuit of the secondary winding 32 during the first charging phase, the first MOSFET 41 should turn off before a positive voltage is present across the secondary winding 32 as a result of conducting driving of the first half-bridge switch 21. Correspondingly, after the end of the first charging phase, the first MOSFET 41 should be driven in the conducting state again only when a positive secondary voltage V32 is no longer present. Referring to FIG. 3, this can be achieved by virtue of the fact that the drive signal S41 of the first MOSFET 41 has a switch-off edge in temporally offset fashion with respect to a switch-on edge of the drive signal S21 of the first half-bridge switch 21. A temporal delay between the switch-off edge of the drive signal S41 of the first MOSFET 41 and the switch-on edge of the drive signal S21 is designated by Td1 in FIG. 3. Correspondingly, a switch-on edge of the drive signal S41 of the first MOSFET 41 succeeds a switch-off edge of the drive signal S21 in temporally offset fashion. This delayed duration is Td2, for example.

In a corresponding manner, a switch-off edge of the drive signal S42 of the second MOSFET 42 precedes a switch-on edge of the drive signal S22 of the second half-bridge switch temporally by a delay duration Td1, and a switch-on edge of the drive signal S42 of the second MOSFET 42 succeeds a switch-off edge of the drive signal S22 after a delay duration Td2. This prevents a short circuit of the secondary winding during the second charging phase.

During the time duration between the turn-off of the MOS channel of the respective MOSFET 41, 42 and a commutation or polarity reversal of the voltage present across the MOSFET 41, 42, the body diode of the respective MOSFET 41, 42 accepts the freewheeling current. Before the beginning of the first charging phase, that is to say before a positive secondary voltage V32 is present, this is the body diode of the first MOSFET 41, and before the beginning of the second charging phase, that is to say before a negative secondary voltage V32 is present, this is the body diode of the second MOSFET 42. After the conclusion of the respective charging phase, the body diodes likewise accept the freewheeling current before the MOS channel of the respective MOSFET 41, 42 is driven in the conducting state again. In this case, the operating phases in which the body diode of a MOSFET 41, 42 is commutated from the conducting state to the blocking state by polarity reversal of the voltage present across the MOSFET 41, 42 are critical with regard to an occurrence of an overvoltage. This is the case before the beginning of the first charging phase I in the case of the body diode of the first MOSFET 41 and before the beginning of the second charging phase III in the case of the body diode of the second MOSFET 42. The operating phases in which the body diodes are commutated from the blocking state to the conducting state, as is the case after the first charging phase I in the case of the body diode of the first MOSFET 41 and after the second charging phase III in the case of the body diode of the second MOSFET 42, are noncritical with regard to the occurrence of overvoltage spikes.

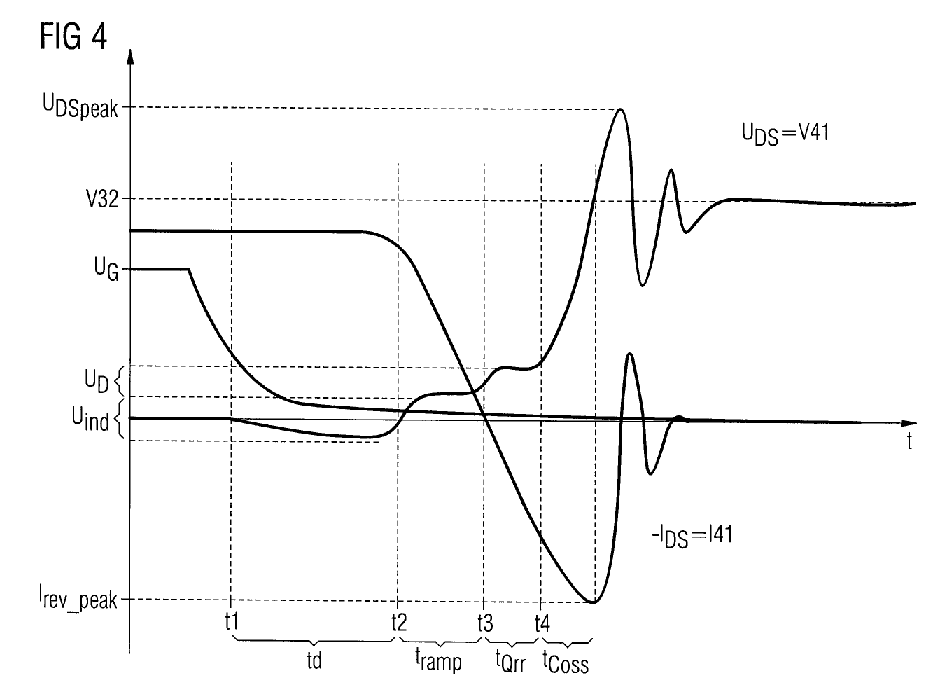

The effects which lead to the occurrence of overvoltage spikes during a commutation of the body diode from the conducting state to the blocking state are explained below by way of example with reference to the MOSFET 41. In this respect, FIG. 4 illustrates temporal profiles of a drain-source voltage V41 present across the MOSFET 41, of a current −I_{DS} flowing through the MOSFET 41 in the source-drain direction, the current corresponding to the current I41 in accordance with FIG. 1, and also of a drive voltage Vgs41 of the MOSFET 41, which results from the drive signal S41. In FIG. 4, t1 designates an instant up to which the MOS channel is in the conducting state. At the instant t1, the drive voltage Vgs41 falls below the threshold value of the MOSFET 41. A freewheeling current flowing through the component up to that point is then accepted by the body diode, and the magnitude of a voltage drop across the component increases in this case. t2 designates an instant as of which the current through the body diode decreases due to a positive secondary voltage V32.

During the delay time between the turn-off of the MOS channel and the beginning of the voltage reversal, electrical charge is stored in the body diode. This storage charge crucially influences the magnitude of the voltage spike occurring across the component before the voltage present across the component settles to the secondary voltage V32. In this case, the charge stored in the body diode increases approximately linearly with time until the body diode is completely flooded with charge carriers. If the delay time td between the turn-off of the MOS channel and the voltage reversal is less than the time duration required for completely flooding the body diode with charge carriers, then the storage charge can be reduced by reducing the delay duration td, which simultaneously results in a reduction of the overvoltage spike. It may be an aim, therefore, to set the delay duration between the turn-off of the MOS channel of a MOSFET used as freewheeling element and the polarity reversal of the voltage across the MOSFET, which is caused by the switching on of a primary side switch, to the shortest possible time durations, but in the process to provide that the MOS channel of the MOSFET reliably turns off when the respective primary-side switch is switched on. The delay time td illustrated in FIG. 4 between the turn-off of the MOS channel and the polarity reversal of the voltage present across the freewheeling element, for the switching converter illustrated in FIG. 1, is directly dependent on the delay duration Td1 between the blocking driving of the first MOSFET 41 and the conducting driving of the first half-bridge switch 21 or between the blocking driving of the second MOSFET 42 and the conducting driving of the second half-bridge switch 22. In order to achieve a shortest possible delay time, on the one hand, but on the other hand to provide that no short circuit of the secondary winding 32 occurs, provision is made for adaptively setting the delay duration Td1 in a manner yet to be explained.

Before various adaptation mechanisms are explained, firstly a possible exemplary realization of the drive circuit 60 for generating the primary-side drive signals S21, S22 and the secondary-side drive signals S41, S42 is explained with reference to FIG. 5. This drive circuit 60 has a pulse width modulator 61, which is designed to generate two pulse-width-modulated signals S21′, S22′ depending on an output voltage signal Sout, the primary-sidedrive signals S21, S22 resulting directly from the pulse-width-modulatd signals in a manner yet to be explained. The pulse width modulator 61 can be a conventional pulse width modulator for the generation of primary-side drive signals of a forward converter having a primary-side half-bridge topology. In this case, the output voltage signal Sout is dependent on the output voltage Vout and, referring to FIG. 1, is generated from the output voltage Vout for example by means of a voltage divider 50 having voltage divider resistors 51, 52. In this case, the output voltage signal Sout serves for setting the duty cycle of the primary-side drive signals. If the output voltage falls below a predetermined desired value, for example, then the switched-on durations or the duty cycle of the primary-side drive signals are increased in order thereby to increase the power consumption and thereby to counteract a further fall in the output voltage Vout.

The drive circuit 60 additionally has an adaptation circuit 63, which is designed to generate the primary-side drive signals S21, S22 and also the secondary-side drive signals S41, S42 for the secondary-side freewheeling elements and to temporally coordinate these signals with one another. In the example illustrated, the adaptation circuit 63 has first and second delay elements 631, 632, to which the pulse-width-modulated output signals S21′, S22′ of the pulse width modulator 61 are fed and at the outputs of which the primary-side drive signals S21, S22 are available. The delay elements have a settable delay duration with a delay duration dependent on a delay signal Sdel. A transfer circuit 64 is provided for transferring primary-side drive signals from the secondary side to the primary side of the switching converter, the transfer circuit 64 being suitable for signal transfer across the potential barrier formed between the primary side and the secondary side of the switching converter. The signal profiles of the primary-side drive signals are not altered by this transfer. For differentiation, the primary-side drive signals that are fed into the transfer circuit 64 are designated by the index s in FIG. 5.

In the example illustrated, the primary-side drive signals S21, S22 result from the pulse-width-modulated output signals S21′, S22′ of the pulse width modulator 61 as a result of a time delay by means of the delay elements 631, 632, the delay elements having a settable delay time in a manner yet to be explained. The temporal profile of the pulse-width-modulated output signals S21′, S22′ is illustrated in FIG. 3 together with the time profile of the primary-side drive signals S21, S22. In the adaptation circuit 63 illustrated in FIG. 5, a rising edge of the first pulse-width-modulated output signal S21′ determines the instant of a falling edge of the drive signal S41 of the first MOSFET 41, while a rising edge of the second pulse-width-modulated output signal S22′ determines a falling edge of the drive signal S42 of the second MOSFET 42. For generating these drive signals S41, S42, the adaptation circuit 63 comprises a first flip-flop 635, to the reset input R of which the first pulse-width-modulated output signal S21′ is fed, and a second flip-flop 636, to the reset input R of which the second pulse-width-modulated output signal S22′ is fed. The flip-flops 635, 636 are set for generating a switch-on level of the drive signals S41, S42 in each case in time-delayed fashion after falling edges of the primary-side drive signals S21, S22. For this purpose, the adaptation circuit 63 has a third delay element 633, to which the first primary-side drive signal S21 is fed, and the output of which is connected to an inverting set input S of the first flip-flop 635. The second primary-side drive signal S22 is fed to a fourth delay element 634. An output of the fourth delay element 634 is fed to an inverting set input of the second flip-flop 636.

In the adaptation circuit 63 illustrated, the first and the second delay elements 631, 632 in each case determine the delay duration Td1 between the falling edges of the drive signals S41, S42 of the freewheeling elements and the rising edges of the primary-side drive signals S21, S22. The third and the fourth delay elements in each case determine the delay durations Td2 between the falling edges of the primary-side drive signals S21, S22 and the rising edges of the drive signals S41, S42 of the freewheeling elements 41, 42. Since, in the manner already explained, the second delay duration Td2 is not critical with regard to overvoltage spikes, the delay time of the third and fourth delay elements 633, 634 can be fixedly predetermined. The delay time of the third and fourth delay elements 633, 634 could also be settable depending on a delay signal Sdel, however, in a manner corresponding to the first and second delay elements 631, 632. The delay signal Sdel which determines the delay durations Td1 is generated by a delay signal generating circuit 65.

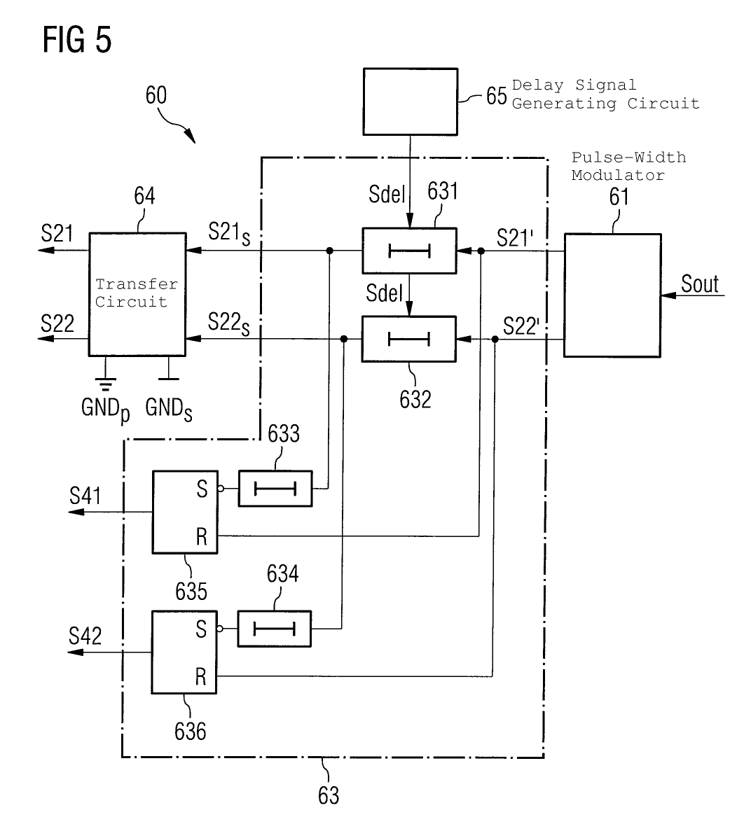

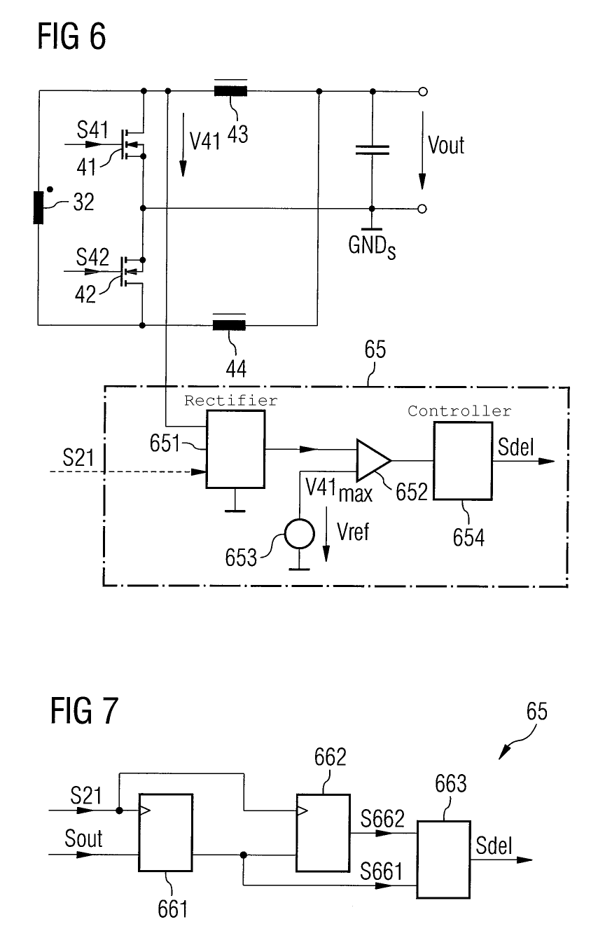

A first example of the delay signal generating circuit 65 is illustrated in FIG. 6. This delay signal generating circuit 65 illustrated in FIG. 6 is designed to determine a voltage that occurs maximally across one of the freewheeling elements during a drive cycle, and to set the delay signal Sdel depending on the voltage. For this purpose, the delay signal generating circuit 65 illustrated comprises a peak value rectifier 651, to which the voltage across one of the freewheeling elements, in the example the voltage V41 across the first MOSFET 41, is fed as input signal. The peak value rectifier 651 is designed to determine the peak value, i.e. the maximum value, of the voltage V41 during a drive cycle and to make this maximum value available at an output as peak value signal V41ₘₐₓ. The peak value rectifier 651 contains an item of information about the duration of a drive cycle for example through one of the primary-side drive signals, such as the first drive signal S21, for example. The peak value rectifier 651 begins with a new evaluation of the voltage V41 across the freewheeling element 41 for example in each case with a rising edge of the drive signal S21.

The peak value signal V41ₘₐₓ available at the output of the peak value rectifier 651 is fed to a comparator 652, which compares the peak value signal with a reference value Vref generated by a reference voltage source 653. A comparison signal S652 available at the output of the comparator 652 is fed to a controller 654, which makes the delay signal Sdel available. The circuit components of the delay signal generating circuit 65 are coordinated with one another in such a way that the delay signal Sdel or a delay time resulting from the delay signal Sdel becomes smaller if the peak value signal V41ₘₐₓ during a drive cycle is greater than the predetermined reference value Vref For if the peak value signal V41ₘₐₓ exceeds the reference signal Vref, it is assumed that the delay duration is too long, such that a large storage charge leading to a high overvoltage spike is stored in the body diode of the MOSFET 41. The controller 654 can be embodied as a proportional controller, integral controller or else as a proportional-integral controller. In this case, the output signal of the comparator 652 can be proportional to a difference between the peak value signal V41ₘₐₓ and the reference signal Vref. Furthermore, the controller 654 can also be realized in such a way that each time when the peak value signal V41ₘₐₓ exceeds the reference value Vref during a drive cycle, the controller reduces the delay signal Sdel by a predetermined value, or increases it by a predetermined value if the peak value signal V41ₘₐₓ is less than the reference value Vref In this case, the comparator 652 is designed in such a way that only an item of information about whether the peak value signal V41ₘₐₓ is greater or less than the reference value Vref is available at its output. In this case, the comparator 652 can be realized as a window comparator, for example, which brings about a change in the delay signal Sdel by means of the controller 654 only when the peak value signal V41ₘₐₓ deviates from the reference value Vref by a predetermined value upward or downward.

In the manner already explained, the value of the peak value signal increases if the delay time increases within a time window which begins with an instant at which a current flow through the body diode commences and which ends with an instant at which the body diode is completely flooded with charge carriers. By contrast, if the delay time is so short that a reversal of the polarity of the voltages V41, V42 present across the MOSFETs 41, 42 occurs actually before the MOS channels turn off, then high voltage spikes likewise occur when the MOS channels turn off. Before the turn-off of the MOS channels, undesirable “shunt currents” flow through the rectifier elements 41, 42 in this case. The voltage spikes occurring in this case are larger than the voltage spikes which occur in the case of an optimally set delay time, that is to say when, on the one hand, no shunt currents flow and when, on the other hand, no charge—or only a negligibly small charge with regard to the generation of voltage spikes—is stored in the body diode.

The optimal delay time with regard to the generation of voltage spikes is thus reached when a minimum of the voltage spikes that can be determined across the rectifier elements 41, 42 is reached. In order to determine the minimum, the delay time is set at the beginning of the adaptation process, for example, to an initial value which is certainly high enough that no shunt currents can occur. Proceeding from the initial value, the delay time is then subsequently reduced—for example with each drive cycle—and the voltage spikes across the rectifier elements 41, 42 are evaluated. The voltage spikes determined during a drive cycle are compared for example with the voltage spikes that occurred during the directly preceding drive cycle. In this case, the delay time is reduced anew with each drive cycle as long as a reduction of the voltage spikes results from a reduction of the delay time. By contrast, if an increase in the voltage spikes results from a further reduction of the delay time, then the optimum of the delay time has been exceeded in the direction of excessively short delay times and the last performed reduction of the delay time is reversed, for example, and the delay time then obtained can be maintained for further operation. A comparison of the voltage spikes with a reference value is not necessary in this method.

One example provides for the voltage spikes determined for the optimum delay time to be stored and to be compared with the voltage spikes that occur during the subsequent drive cycles. In this case, a new control process for determining the optimum delay duration is begun for example when the measured voltage spikes deviate from the stored values by more than a predetermined value. Such a deviation can for example indicate a temperature-dictated alteration of the signal propagation times. The new control process can start for example with the preset initial delay time. As an alternative, by means of a lengthening of the stored delay time in one drive cycle and by means of a shortening of the stored delay time in another cycle and by means of a change in the voltage spikes which accompanies this variation of the delay time, it is possible to determine whether the new optimum of the delay time is shorter or longer than the stored value. The delay time is subsequently lengthened or shortened, in the corresponding direction until the new optimum is reached.

The delay signal generating circuit 65 illustrated in FIG. 6 provides only one delay signal Sdel, which is fed both to the first and to the second delay element 631, 632 of the drive circuit 60 illustrated in FIG. 5. As an alternative, there is the possibility of providing two delay signal generating circuits, a first one of which evaluates the voltage across the first freewheeling element 41 and a second one of which evaluates the voltage across the second freewheeling element 42, and of feeding a first delay signal provided by the first delay signal generating circuit to the first delay element 631 and a second delay signal generated by the second delay signal generating circuit to the second delay element.

One variant of the explained method for setting the optimum delay time provides for comparing the voltage spikes that occur, or the peak value signal V41ₘₐₓ with a second reference signal, which is greater than the reference signal Vref, and for turning off the switching converter if the voltage spikes exceed the second reference signal. The turn-off is effected for example by the primary-side switches 21, 22 being driven permanently in the blocking state. As an alternative or in addition there is the possibility of turning off the switching converter if a shunt current flows through the rectifier elements 41, 42. For this purpose, it can merely involve determining the current direction of a current flowing through the MOSFETs 41, 42 in the conducting state and to turn off the switching converter if a current flow in a direction counter to the reverse direction of the body diodes is determined.

It was assumed for the previous explanation that falling edges of the drive signals for the freewheeling elements are generated temporally before rising edges of the primary-side drive signals. As already explained, the primary-side drive signals are generated on the secondary side and transferred to the primary side via the transfer circuit 64. Due to signal propagation times via the transfer circuit 64 and due to switch delays, however, it may even become desirable to generate rising edges of the primary-side drive signals actually before falling edges of the drive signals of the freewheeling elements in order ultimately nevertheless to have the effect that the freewheeling elements 41, 42 are in the blocking state before the primary-side switches 21, 22 are in the conducting state. Referring to the signal profiles in FIG. 3, this would correspond to a negative delay duration Td1 between the falling edges of the drive signals S41, S42 of the freewheeling elements and the rising edges of the primary-side drive signals S21. The pulse-width-modulated output signals S21′, S22′ of the pulse width modulator 61 in accordance with FIG. 5 can be used directly as primary-side drive signals in this case. Delay elements having a variable delay time would have to be provided in this case in order to generate falling edges of the drive signals of the freewheeling elements after the elapsing of the variable delay time after rising edges of the primary-side drive signals.

FIG. 7 shows a further example of a delay signal generating circuit 65. This delay signal generating circuit 65 makes use of the fact that the efficiency of the switching converter with the load remaining the same is dependent on the setting of the delay time between a blocking driving of the secondary-side freewheeling elements and a conducting driving of the primary-side switches. If a long delay time is set, then a freewheeling current flows through the body diodes for a long time. This results in a high storage charge, which contributes to increasing the switching losses.

Furthermore, the voltage drop across the conducting body diode is higher than that across the conducting MOS channel, which likewise contributes to an increase in the switching losses. The delay signal generating circuit illustrated in FIG. 7 provides for comparing the efficiency of the switching converter during successive drive cycles with one another and adapting the delay time depending on this comparison.

Power consumption of a load connected to the switching converter remaining the same, the output voltage Vout of the switching converter directly represents a measure of the efficiency of the switching converter. If the output voltage Vout decreases after a change in the delay duration, then with the power consumption of the load remaining the same a reduction of the efficiency can be deduced. In this case, the previously performed change in the delay duration is reversed and/or the delay duration is changed in the other direction, that is to say that the delay duration is shortened if the efficiency deteriorated after a previously performed lengthening of the delay duration.

The delay signal generating circuit illustrated in FIG. 7 has a sample and hold element 661, which samples the output voltage or the output voltage signal Sout dependent on the output voltage in each case at predetermined instants during a drive cycle. The sampling instants are predetermined for example by one of the primary-side drive signals, in the example the first drive signal S21. In order to have available samples of the output voltage from two successive drive cycles, the delay signal generating circuit 65 illustrated in FIG. 7 has a register 662, in which is stored a sample of the sample and hold element 661 in each case for the duration of a drive cycle. The sample is stored for example according to the same signal that determines the sampling instants. A present sample S661 available at the output of the sample and hold element 661 and a sample S662 from the previous drive cycle available at the output of the register are fed to a control circuit 663 for generating the delay signal Sdel. The control circuit 663 compares the two samples S661, S662 and changes the delay signal Sdel if a comparison of these two sample signals S661, S662 reveals that the efficiency of the switching converter has deteriorated from the earlier drive cycle to the current drive cycle. In this case, one measure of a deterioration in the efficiency is a reduction of the output voltage from the preceding drive cycle to the current drive cycle. If the delay signal was changed from the preceding drive cycle to the current drive cycle, then when a deterioration in the efficiency is detected, this change is reversed and the delay signal Sdel and/or the delay signal is changed in the opposite direction for the next drive cycle.

A further method for optimizing the delay time provides for evaluating the temperature of the rectifier elements instead of the voltage spikes across the rectifier elements. This makes use of the fact that the temperature behaves in a manner corresponding to the voltage spikes, that is to say that if high voltage spikes occur on account of a delay time that has not been set optimally, then correspondingly high temperatures of the rectifier elements occur. The evaluation methods explained previously for the voltage spikes can thus be applied correspondingly to the temperature.

A control loop for adapting a duty cycle of the primary-side drive signals S21, S22 upon deviation of the output voltage Vout from a desired value is too slow, on account of an integral control action of the control loop that is yet to be explained, to react even in the case of short-term fluctuations in the output voltage, that is to say to react in the case of those fluctuations in the output voltage Vout from drive cycle to drive cycle which are caused by a variation of the delay duration.

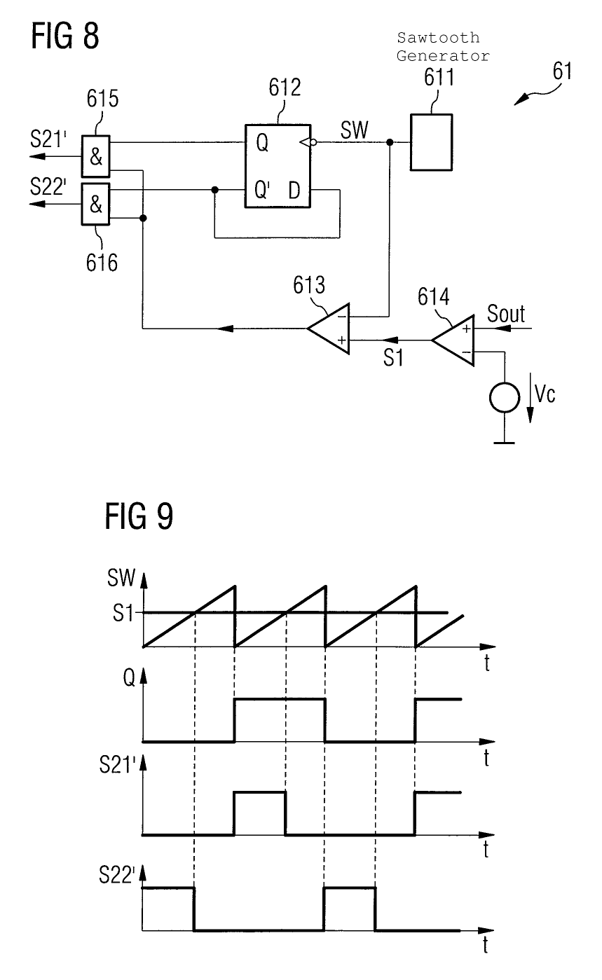

In order to afford a better understanding, the control of the output voltage Vout is explained below with reference to FIGS. 8 and 9, which illustrate an example of a pulse width modulator 61 for generating the pulse-width-modulated signals S21′, S22′ and temporal profiles of the signals occurring in the pulse width modulator 61. The pulse width modulator 61 illustrated in FIG. 8 has a sawtooth generator 611, which generates a sawtooth signal SW. The sawtooth signal SW is fed to a clock input of a D-type flip-flop 612, the inverting output Q′ of which is fed back to the data input D. In this pulse width modulator, the sawtooth signal SW is compared with a control signal S1 generated by a controller 614 depending on a comparison of the output voltage signal Sout with a desired value signal Vc. In this case, the desired value signal Vc determines the desired value to which the output voltage Vout is to be adjusted. The controller 614 has for example an integral action (I action), or a proportional-integral action (PI action) and generates the control signal S1 depending on the difference between the output voltage signal Sout and the desired value signal Vc. In this pulse width modulator 61, an output signal S613 of the comparator 613 is fed to first inputs of second AND gates 615, 616, the non-inverted output signal of the flip-flop 612 being fed to a second input of the first AND gate 615 and the inverted output signal of the flip-flop 612 being fed to the second input of the second AND gate 616. The first pulse-width-modulated signal S21′ is available at the output of the first AND gate 615, and the second pulse-width modulated signal S22′ is available at the output of the second AND gate 616. These pulse-width-modulated signals S21′, S22′ begin in temporally offset fashion offset by a signal period of the sawtooth signal SW with every second signal period. The drive signals end in each case when the sawtooth signal SW exceeds the control signal S1 during the respective period.

In this case, the controller 614 is realized in such a way that the control signal S1 becomes larger if the output voltage Vout falls due to a higher power consumption of a load connected to the output. As a result, the duty cycle increases until the power consumption of the switching converter has risen to such an extent as to cover the increased power demand of the load. In this case, the control action of the controller 614 crucially determines a time delay between a change in the output voltage and a change in the duty cycle.

In the drive circuit in accordance with FIG. 5, any transfer circuits suitable for signal transfer across a potential barrier are suitable as transfer circuit 64 for transferring the drive signals generated on the secondary side to the primary side. Examples of such transfer circuits are optocouplers, drive transformers or radio transfer devices for signal transfer by means of radio frequency signals.

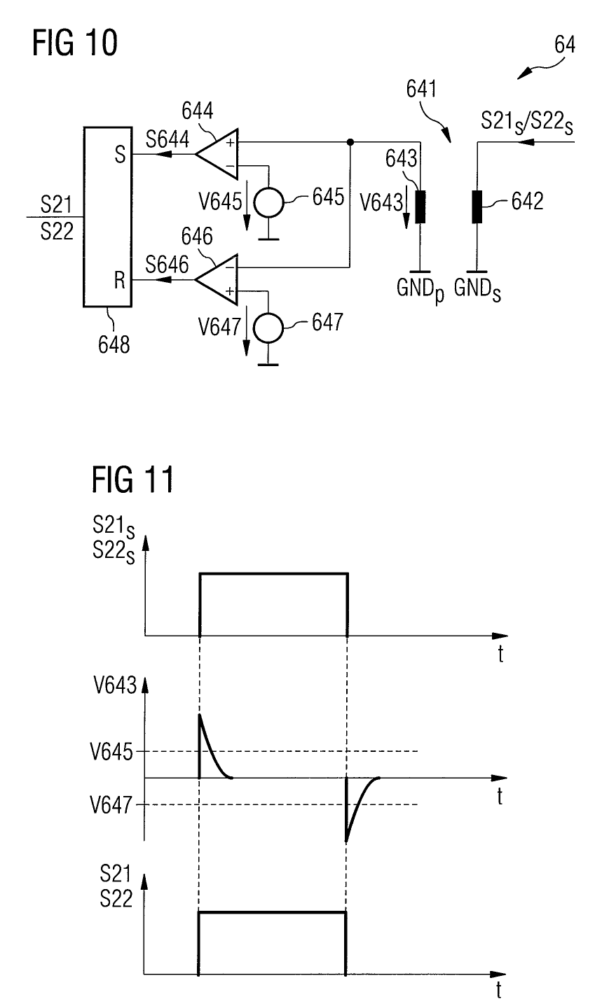

A suitable transfer circuit may be, for example, a transfer circuit comprising a coreless transformer, as is illustrated in FIG. 10, for example. Coreless transformers are transformers without a transformer core, which can be realized in space-saving fashion in or on integrated circuits. FIG. 10 shows a transfer circuit 64 comprising a coreless transformer 641, which has a primary winding 642 arranged on the secondary side in the switching converter, and which has a secondary winding 643 arranged on the primary side in the switching converter. The transfer circuit 64 can have two coreless transformers, each of the coreless transformers being used for transferring one of the primary-side drive signals. Furthermore, there is also the possibility of transferring the primary-side drive signals by means of time division multiplexing via a single coreless transformer. This makes use of the fact that the switch-on periods of the two primary-side drive signals do not overlap temporally.

An illustrative functioning of the transfer circuit 64 is explained below for a transfer channel having a coreless transformer 641 via which—as already explained—it is possible to transfer a single drive signal or both drive signals using time division multiplexing. The drive signal S21ₛ and/or S22ₛ generated on the secondary side can be fed directly to the primary winding 642 of the coreless transformer. Upon a rising edge of the drive signal S21ₛ and/or S22ₛ, a positive voltage pulse of a voltage V643 results across the secondary winding of the coreless transformer 641. A temporal profile of this secondary voltage V643 is illustrated in FIG. 11 depending on the temporal profile of the respective drive signal S21ₛ and/or S22ₛ. Upon a falling edge of the drive signal S21ₛ and/or S22ₛ, a negative voltage pulse of the secondary voltage V643 arises. In order to reconstruct the transferred drive signal S21ₛ and/or S22ₛ from the secondary voltage V643, the transfer circuit 64 has an evaluation circuit connected to the secondary winding 643. The evaluation circuit comprises two comparators 644, 646, which compare the secondary voltage V643 with a first voltage level V645, a positive voltage level in the example, and a second voltage level, a negative voltage level V647 in the example. If the secondary voltage V643 exceeds the positive voltage level, then a rising edge of the transferred drive signal is assumed. If the secondary voltage V643 falls below the negative voltage level, then a falling edge of the transferred drive signal S21ₛ and/or S22ₛ is assumed. Output signals S644, S646 of the comparators are fed to a flip-flop 648, which is set by the first comparator 644 if the secondary voltage V643 exceeds the positive voltage level, and which is reset by the second comparator 646 if the secondary voltage V643 falls below the negative voltage level. The drive signals S21, S22 provided by the drive circuit (60 in FIG. 1) are available at the output of the flip-flop 648 when using the transfer circuit 64 illustrated in FIG. 10.

A transfer circuit 64 having a coreless transformer as transfer element may enable a very fast signal transfer, that is to say a signal transfer with small signal delays, and at high transfer rates that may be in the range of 100 MHz and higher. Unlike in the case of optocouplers, for example, the transfer properties of a coreless transformer are moreover not dependent—or dependent only to a significantly smaller extent—on secondary influences such as, for example, ambient temperature or (total) operating duration.

It goes without saying that the explained concept of adaptively setting a temporal interval between the conducting driving of a switch arranged on the primary side in a switching converter and a blocking driving of a switchable freewheeling element in the switching converter is not restricted to the circuit topology explained with reference to FIG. 1, but rather can be applied to any switching converter topologies in which there is present on the secondary side a switchable freewheeling element which is commutated after a primary-side switch has been switched on.

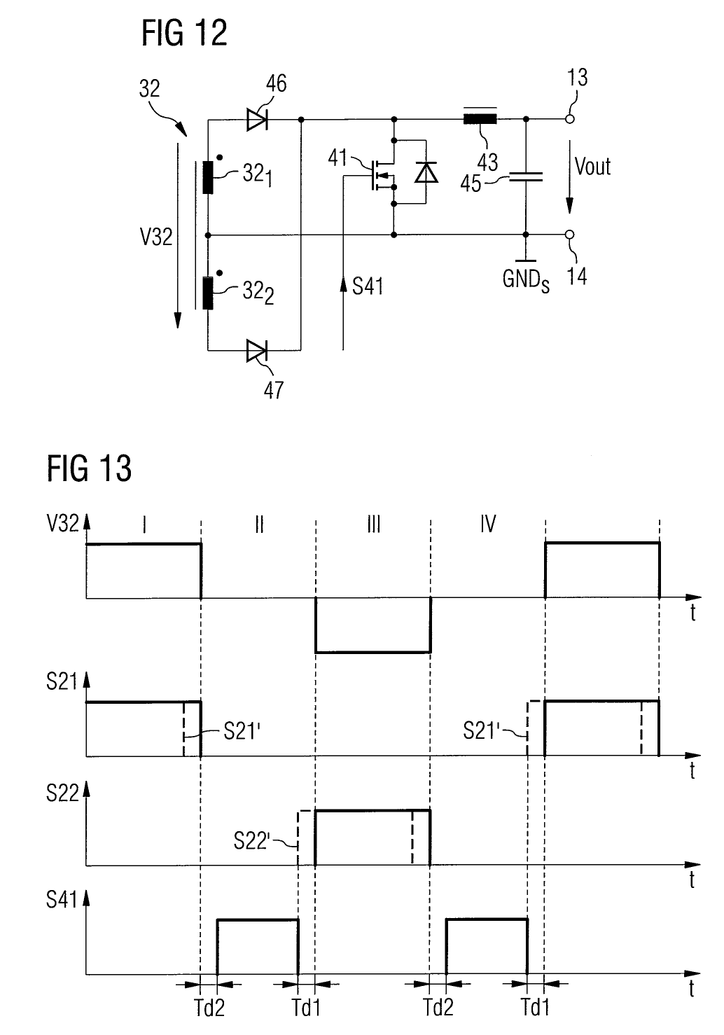

FIG. 12 shows, for the switching converter in accordance with FIG. 1, an alternative to the secondary-side topology illustrated in FIG. 1. In the case of the circuit topology illustrated in FIG. 12, the secondary winding 32 has a center tap which is connected to the second output terminal 14 and which is therefore at secondary-side reference-ground potential GNDₛ. The center tap subdivides the secondary winding 32 into two partial windings, a first partial winding 32₁ and a second partial winding 32₂. In the case of the circuit topology illustrated in FIG. 12, only one storage inductor 43 is present on the secondary side, the storage inductor being connected in series with the output capacitor 45. A connection of the first partial winding 32₁ that is remote from the second output terminal 14 is connected to the storage inductor 43 via a first rectifier element 46, for example a diode, and a connection of the second partial winding 32₂ that is remote from the second output terminal 14 is connected to the storage inductor 43 via a second rectifier element 47, for example a diode. A freewheeling element 41, which is realized as an n-channel MOSFET with an integrated body diode in the example, is connected in parallel with the series circuit formed by the storage inductor 43 and the output capacitor 45.

The functioning of the secondary-side rectifying arrangement illustrated in FIG. 12 is explained below on the basis of a temporal profile of the secondary voltage V32 illustrated in FIG. 13. FIG. 13 additionally illustrates temporal profiles of the primary-side drive signals S21, S22 of the half-bridge switches (21, 22 in FIG. 1) and also a temporal profile of the drive signal S41 of the freewheeling element 41 realized as a MOSFET. In accordance with the explanations concerning FIG. 2, a drive cycle can be subdivided into four different phases, a first and a second charging phase I, III and also two freewheeling phases II, IV. During the first charging phase I, a positive secondary voltage V32 is present across the secondary winding 32. The first rectifier element 46 is forward-biased during this operating phase, the storage inductor 43 taking up energy via the first partial winding 32₁ of the secondary winding 32. In order to avoid a short circuit of the first partial winding 32₁, the freewheeling element 41 is driven in the blocking state during this operating state. During the subsequent first freewheeling phase II, the freewheeling element 41 accepts a freewheeling current of the storage inductor 43. In the case, the MOSFET 41 is connected up in such a way that the freewheeling current can be accepted through the body diode of the MOSFET 41. In order to reduce switching losses, the MOSFET 41 is driven in the conducting state, however, during this operating phase. During the subsequent second charging phase III, a negative secondary voltage V32 is present across the secondary winding 32. The storage inductor 43 takes up energy from the second partial winding 32₂ during the second charging phase III. The second rectifier element 47 is forward-biased during this operating state. The freewheeling element 41 is driven in the blocking state during this operating state in order to avoid a short circuit of the second partial winding 32₂. During the subsequent second freewheeling phase IV, the freewheeling element 41 accepts a freewheeling current of the storage inductor 43. The freewheeling current could be accepted completely through the body diode 41; in order to reduce switching losses, however, the freewheeling element 41 is driven in the conducting state during this operating phase.

The rectifier elements 46, 47 could be realized as MOSFETs with an integrated freewheeling diode in the manner corresponding to the freewheeling element 41. A conducting driving of the MOSFET used as first rectifier element 46 could take place simultaneously with a driving of the first half-bridge switch 21, that is to say depending on the first drive signal S21, and a conducting driving of the MOSFET used as second rectifier element 47 could then take place simultaneously with the conducting driving of the second half-bridge switch 22 or depending on the second drive signal S22. In this case, the rectifier elements can be driven in the conducting state with a temporal offset after the conducting driving of the respective half-bridge switch 21 or 22 and can be driven in the blocking state with a temporal offset before the blocking driving of the respective half-bridge switch 21 or 22. In this case, the temporal delays are noncritical with regard to the occurrence of overvoltage spikes. A maximum reverse voltage is present across these rectifier elements 46, 47 during the freewheeling phases. In this case, the maximum reverse voltage corresponds to a voltage drop across the forward-biased freewheeling element 41; the voltage drop is at most in the region of the forward voltage of the body diode and thus approximately 0.7 V.

In order to reliably prevent the partial windings 32₁, 32₂ of the secondary winding 32 from being short-circuited during the charging phases, a conducting driving of the freewheeling element S41 takes place in time-delayed fashion after a blocking driving of the primary-side half-bridge switches 21, 22, and a blocking driving of the freewheeling element 41 takes place in temporally offset fashion before a conducting driving of the primary-side switches 21, 22. Delay times between falling edges of the primary-side drive signals and rising edges of the drive signal S41 of the freewheeling element 41 are designated by Td2 in FIG. 13. Delay times between falling edges of the drive signal S41 of the freewheeling element 41 and rising edges of the drive signals S21 and S22 are designated by Td1 in FIG. 13. In this case, the delay durations between the falling edges of the drive signal S41 of the freewheeling element 41 and the rising edges of the primary-side drive signals S21, S22 are critical with regard to the occurrence of overvoltage spikes. During this delay duration Td1, the body diode of the MOSFET 41 accepts the freewheeling current of the storage inductor 43, a hard commutation of the body diode subsequently occurring as soon as a positive voltage is present across the first partial winding 32₁ or a negative voltage is present across the second partial winding 32₂. Provision is made, therefore, for adaptively setting this delay time Td1. In this case, the methods explained above can be applied for setting the delay time, that is to say that for example a maximum voltage occurring across the freewheeling element 41 can be evaluated, or the efficiency of the switching converter can be evaluated from drive cycle to drive cycle.

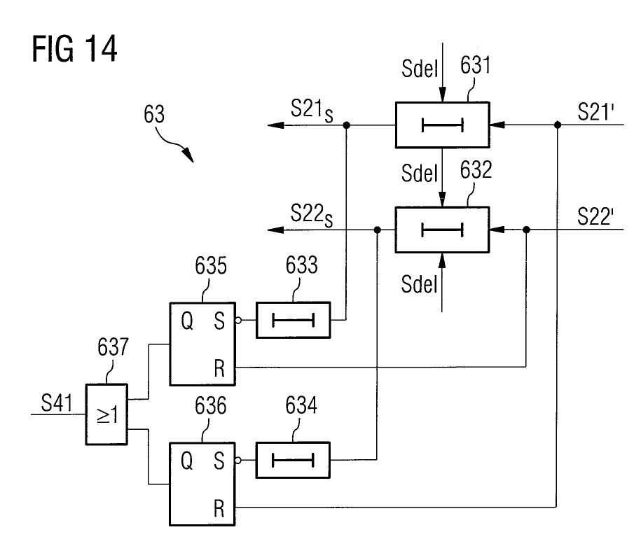

An example of the adaptation circuit 63 for generating the primary-side drive signals S21, S22 and the drive signal S41 for the freewheeling element 41 in such a way that these signals are temporally related to one another in accordance with the explanations concerning FIG. 13 is illustrated in FIG. 14. The construction of this adaptation circuit corresponds to the adaptation circuit explained with reference to FIG. 5 with the difference that an OR gate 637 is connected downstream of the two flip-flops 635, 636, the drive signal S41 for the freewheeling element 41 being available at the output of the OR gate. In a departure from the adaptation circuit 63 in accordance with FIG. 14, the first flip-flop 635 in the circuit arrangement illustrated in FIG. 14 is reset depending on the second pulse-width-modulated signal S22′, while the second flip-flop 636 is reset depending on the first pulse-width-modulated signal S21′. In this circuit, the first flip-flop 635 serves for generating the drive signal S41 for the freewheeling element 41 during the first freewheeling phase II, while the second flip-flop 636 serves for generating the drive signal S41 for the MOSFET 41 during the second freewheeling phase IV. In this case, the first and second delay elements 631, 632 determine in each case the first delay time Td1 between falling edges of the freewheeling element drive signal S41 and rising edges of the primary-side drive signals. The delay signal Sdel for setting the delay time is fed to these delay elements 631, 632.

The second and third delay elements 633, 634 determine the delay time between falling edges of the primary-side drive signals S21, S22 and rising edges of the freewheeling element drive signal S41. Since the delay time—as already explained—is not critical with regard to the occurrence of overvoltage spikes, the delay times of the delay elements 633, 634 can be chosen to be fixed. It goes without saying, however, that there is also the possibility of realizing the delay elements 633, 634 as variable delay elements to which the delay signal Sdel for setting the delay time is fed.

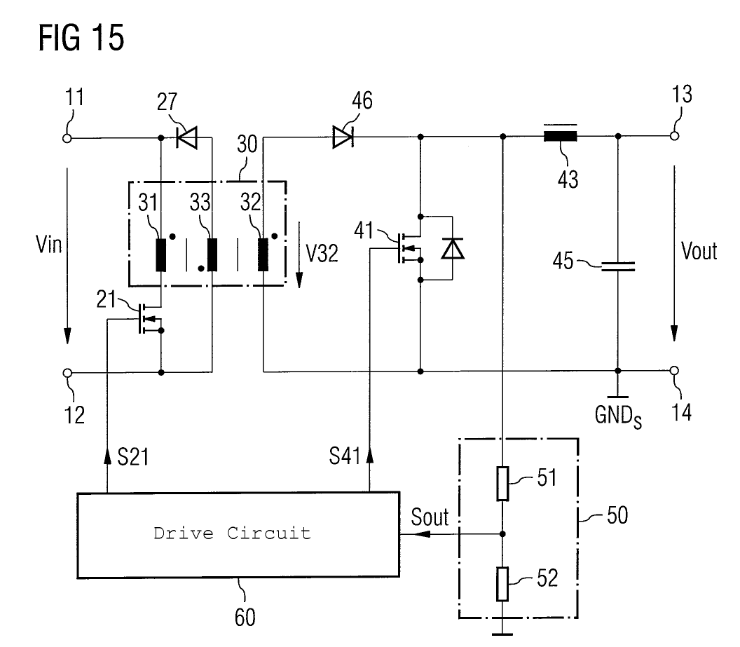

FIG. 15 shows a forward converter having only one switch 21 on the primary side, the switch being embodied for example as a transistor, for example as a MOSFET. This one switch is connected in series with the primary winding 31 of the transformer. In order to prevent upon turn-off of the switch 21 on the primary side an overvoltage that results from an energy previously stored in the primary winding 31, the transformer 30 has an auxiliary winding 33 having an opposite winding sense with respect to the winding sense of the primary winding 31 and the secondary winding 32. The auxiliary winding 33 is connected in series with a rectifier element 27, for example a diode. In this case, the series circuit comprising the auxiliary winding 33 and the rectifier element 27 is connected in parallel with the series circuit comprising the primary winding 31 and the switch 21.

The secondary-side topology of the switching converter illustrated in FIG. 15 corresponds to the topology explained with reference to FIG. 12 with the difference that the secondary winding 32 of the switching converter in accordance with FIG. 15 does not have a center tap. Correspondingly, only one rectifier element 46 is present, which is connected between that connection of the secondary winding 32 which is remote from the second output terminal 14 and the storage inductor 43. The secondary-side circuit topology in accordance with FIG. 15 is obtained, proceeding from the circuit topology in accordance with FIG. 12, if the second secondary winding 32₂ and the second rectifier element 47 are dispensed with.

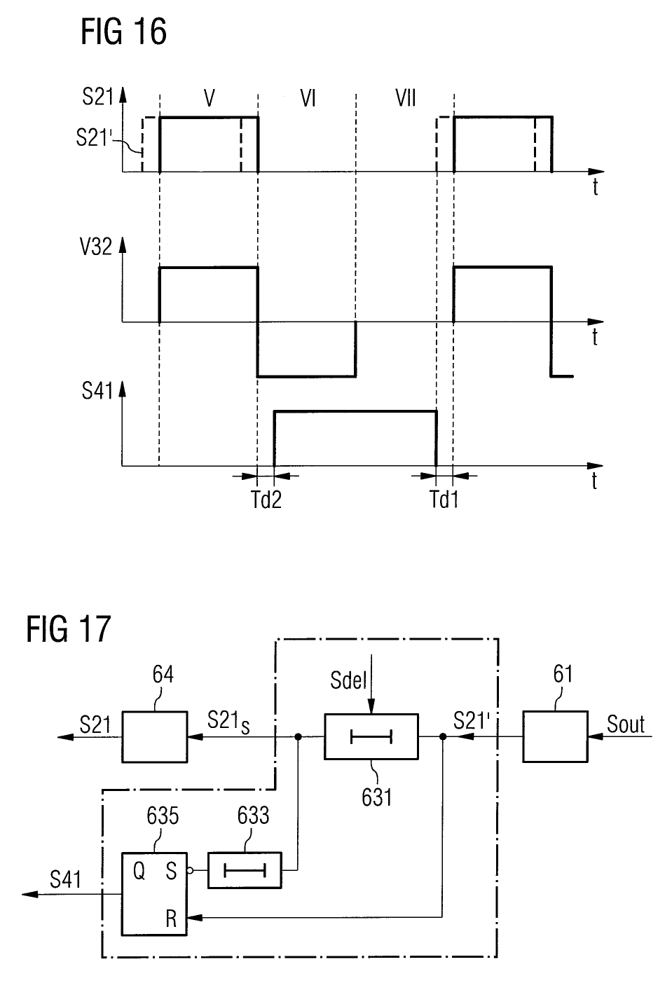

The functioning of the single transistor forward converter illustrated in FIG. 15 is explained below on the basis of temporal profiles of the drive signal S21 of the primary-side switch 21, of the secondary voltage V32 and also of a drive signal S41 of the freewheeling element 41, which are illustrated in FIG. 16. During a drive cycle, the primary-side switch 21 and the secondary-side freewheeling element 41 are driven in the conducting state in each case for a switched-on duration. In this case, a drive cycle is subdivided into three different operating phases, one charging phase V and two freewheeling phases VII. During the charging phase V, the primary-side switch 21 is driven in the conducting state. The secondary voltage V32 is a positive voltage during this charging phase. During this charging phase, the secondary-side rectifier element 46 is forward-biased, whereby the storage inductor 43 takes up energy from the secondary winding 32 via the rectifier element 46. At the end of the charging phase V, when the primary-side switch 21 is in the blocking state, the sign of the secondary voltage V32 changes, whereby the secondary-side rectifier element 46 is in the blocking state. A freewheeling current 43 of the storage inductor that then flows is accepted by the freewheeling element 41. During this operating phase, in which a negative secondary voltage V32 is present, the auxiliary winding feeds the energy previously stored in the primary winding 31 back to the input terminals 11, 12. This phase, representing the first freewheeling phase, ends when the primary winding 31 is completely demagnetized. The secondary voltage V32 then falls to zero until a renewed drive cycle begins with renewed switching on of the primary-side switch 21. The operating phase between the falling of the secondary voltage and the renewed switching on of the primary-side switch forms the second freewheeling phase, during which the freewheeling element 41 remains driven in the conducting state.

In order to avoid a short circuit of the secondary winding 32 during the charging phase V, the freewheeling element 41 is driven in the blocking state during this charging phase. For safety reasons, the freewheeling element 41 is driven in the conducting state only in time-delayed fashion after a blocking driving of the primary-side switch 21. This time delay is designated by Td2 in FIG. 16. Correspondingly, the freewheeling element 41 is driven in the blocking state temporally before a conducting driving of the primary-side semiconductor switch 21. A delay time between a blocking driving of the freewheeling element S41 and a conducting driving of the primary-side semiconductor switch 21 is designated by Td1 in FIG. 16. In this case, the transition between the blocking driving of the freewheeling element 41 and the conducting driving of the primary-side switch 21 is critical with regard to an occurrence of overvoltage spikes at the freewheeling element 41. During this transition region, during which the freewheeling current 43 of the storage inductor still flows through the freewheeling element 41, the body diode of the MOSFET 41 used as freewheeling element accepts the freewheeling current. Upon a subsequent polarity reversal of the voltage present across the freewheeling element 41, the charge stored in the MOSFET 41 with body diode in the conducting state can lead to voltage spikes in the manner explained. Provision is made, therefore, for adaptively setting the delay time Td1 in the manner explained.

A drive circuit 60 for generating the primary-side drive signal S21 and the drive signal S41 for the freewheeling element 41 is illustrated in FIG. 17. This drive circuit 60 has a pulse width modulator 61 for generating a pulse-width-modulated signal S21′ depending on the output voltage signal Sout. The pulse width modulator 46 can be a conventional pulse width modulator for generating a primary-side drive signal for a single transistor forward converter. The pulse-width-modulated signal S21′ is delayed by a delay element 631 with a variable delay time. A signal available at the output of the delay element 631 forms the primary-side drive signal, which is transferred to the primary side via the transfer circuit 46. The delay element 631 is part of an adaptation circuit 63 for generating the primary-side drive signal S21 and the drive signal S41 for the freewheeling element. The construction and functioning of the adaptation circuit 63 correspond to the construction and the functioning of the circuit part of the adaptation circuit 63 in accordance with FIG. 5 which serves for generating the drive signal S41 of the first freewheeling element. The primary-side drive signal S21 available at the output of the variable delay element 631 is in this case fed via a further delay element 631 to an inverting set input 635 of a flip-flop. The drive signal S41 for the freewheeling element 41 is available at the output of the flip-flop. The flip-flop 635 is reset depending on the pulse-width-modulated output signal S21′ of the pulse width modulator 61.

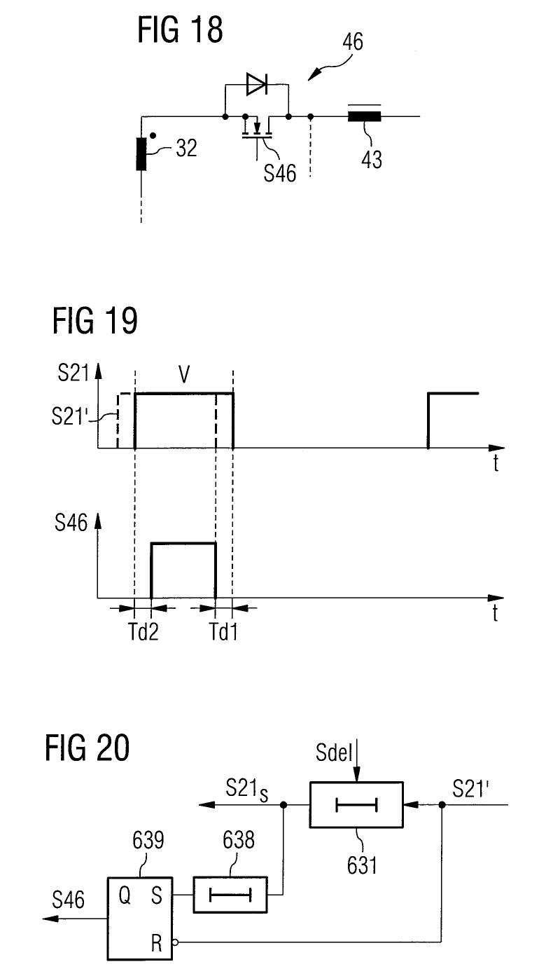

The rectifier element 46 of the switching converter illustrated in FIG. 15 can be realized, referring to FIG. 18, as a MOSFET with an integrated body diode. In this case, the MOSFET—for example an n-channel MOSFET—is connected in such a way that the body diode is forward-biased from the secondary winding 32 to the storage inductor 43. This MOSFET 46 is driven in the conducting state during the charging phase V, that is to say during the time duration during which the primary-side switch 21 is closed and during which a current flows from the secondary winding 32 to the storage inductor 43, in order thereby to reduce the switching losses arising at the freewheeling element 46. For safety reasons, the MOSFET 46 is in this case driven in the conducting state in time-delayed fashion with respect to a conducting driving of the primary-side switch 21 and is driven in the blocking state in time-delayed fashion with respect to a blocking driving of the primary-side switch 21. Otherwise, part of the energy present in the secondary circuit could be transferred back to the primary circuit again via the transformer 30. In this case, the delay time between the blocking driving of the MOSFET 46 and the blocking driving of the primary-side switch 21 is critical with regard to an occurrence of overvoltage spikes. During this time duration, the charging current flows via the body diode of the MOSFET 46, a polarity reversal of the voltage present across the MOSFET 46 subsequently occurring after the opening of the primary-side switch. This delay duration, which is designated by Td1 in FIG. 19, is therefore set adaptively, in which case for example voltage spikes across the rectifier element or the efficiency of the switching converter can be evaluated for the setting of the delay duration in the manner already explained.

It should be pointed out that the rectifier element 46 and the freewheeling elements 41, 42 explained above fulfill the same task, in principle, namely of conducting current in one direction and blocking it in the opposite direction. The freewheeling elements 41, 42 are likewise rectifier elements, although ones having the special function of accepting a freewheeling current of the secondary-side storage inductor outside the charging phases, that is to say when the switch causing the charging operation is driven in the blocking state.

A circuit arrangement for generating the drive signal S46 of the rectifier element 46 from the primary-side drive signal S21ₛ and the pulse-width-modulated signal S21′ is illustrated in FIG. 20. This circuit arrangement has a flip-flop 639, to whose set input the primary-side drive signal S21ₛ is fed via a delay element 638, and to whose inverting reset input the pulse-width-modulated signal S21′ is fed. The drive signal S46 for the rectifier element 46 is available at the output of the flip-flop. In this case, the variable delay element 631 already explained above with reference to FIG. 17 determines a temporal delay between the falling edge of the drive signal S46 of the rectifier element 46 and the falling edge of the drive signal S21. The delay element 638 determines the temporal delay between the rising edge of the primary-side drive signal S21 and the rising edge of the drive signal S46 of the rectifier element 46. When using a common delay element 631 for the generation of the drive signal S41 of the freewheeling element and of the drive signal S46 of the rectifier element, the delay durations Td1 in accordance with FIG. 16 and Td1 in accordance with FIG. 19 are identical. There is also the possibility of providing different delay elements with different adaptively set delay durations. In this case, two delay signal generating circuits are to be provided, a first delay signal generating circuit, which predetermines the delay signal for the temporal delay between the primary-side drive signal S21 and the drive signal S41 of the freewheeling element 41, and a second delay signal generating circuit, which predetermines the delay between the primary-side drive signal S21 and the drive signal S46 of the rectifier element 46.

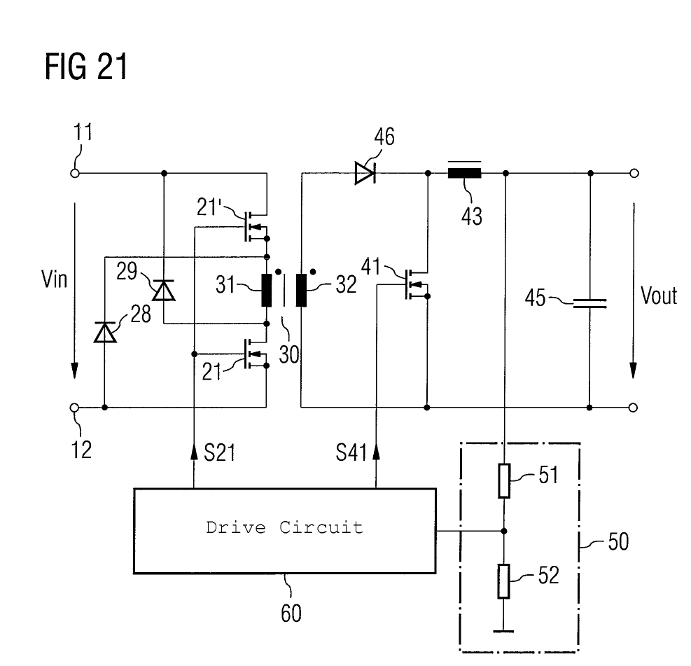

FIG. 21 shows a further example of a switching converter in which the above-explained concept of an adaptive setting of a delay time between a driving of a primary-side switch and a driving of a secondary-side freewheeling element can be applied. This switching converter differs from the switching converter illustrated in FIG. 15 by virtue of the fact that two switches 21, 21′ are present on the primary side, the switches in each case being connected in series with the primary winding of the transformer 30. In this case, a first switch 21 is connected between the second input terminal 12 and the primary winding 31, while a second switch 21′ is connected between the first input terminal 11 and the primary winding 31. The two switches 21, 21′ are driven by a common drive signal S21, and are therefore driven simultaneously in the conducting state and driven simultaneously in the blocking state. An auxiliary winding is not present in the case of the transformer 30, in contrast to the transformer in accordance with FIG. 15. Instead, two freewheeling elements 28, 29 are present, which are realized as diodes, for example. A first freewheeling element 28 from among the freewheeling elements is connected in the forward direction between the second connecting terminal 12 and the node common to the second switch 21′ and the primary winding 31, while a second freewheeling element 29 from among the freewheeling elements is connected in the forward direction between the node common to the primary winding 31 and the first switch 21 and the first connecting terminal 11. After the opening of the two switches 21, 21′, the freewheeling elements 28, 29 enable a demagnetization of the energy stored in the primary winding 31 to the input terminals 11, 12. For the rest, the functioning of the switching converter illustrated in FIG. 21 corresponds to the functioning of the switching converter in accordance with FIG. 15. For example, the temporal profiles of the secondary voltage V32, which is dependent on the drive signal S21 driving the two switches 21, 21′, may correspond to the temporal profiles illustrated in FIG. 16. With regard to the generation of the primary-side drive signal S21 and of the drive signal S41 for the freewheeling element 41, reference is made to the explanations concerning FIGS. 15 to 17. In a manner corresponding to that in the case of the switching converter in accordance with FIG. 15, the rectifier element 46 can be realized as a MOSFET with an integrated body diode. With regard to such a realization and with regard to a driving of the MOSFET, reference is made to the explanations concerning FIGS. 18 to 20.

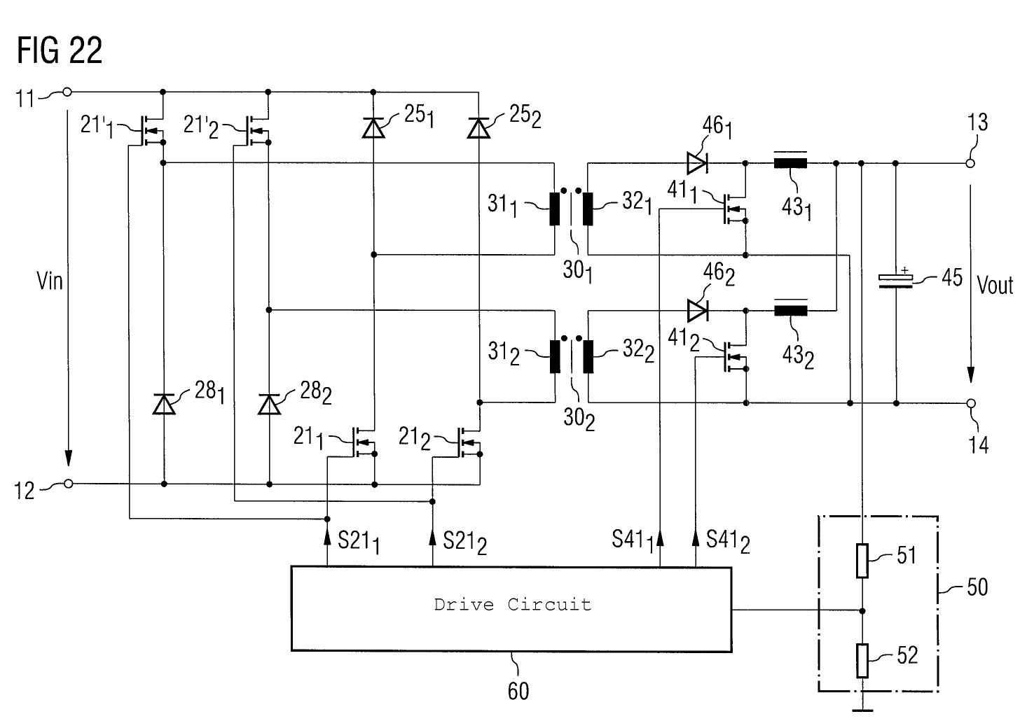

An illustrative circuit topology for a switching converter as illustrated in FIG. 21 is also referred to as a two transistor forward (TTF) converter topology. FIG. 22 shows an illustrative switching converter in which two of such two transistor forward converters are connected in parallel by virtue of input terminals of the two converters being connected to common input terminals and by virtue of output terminals of the two converters being connected to common output terminals. In this case, the two forward converters connected in parallel have a common output transistor 45. In the case of the switching converter topologies in accordance with FIGS. 21 and 22, mutually corresponding circuit components are designated by identical reference symbols. The reference symbols of the circuit components of one of the parallel-connected converters are provided with the index “1” in FIG. 22, while the reference symbols of the circuit components of the other converter are provided with the index “2”. In the case of the switching converter illustrated in FIG. 22, a drive circuit 60 generates two primary-side drive signals S21₁, S21₂, of which a first S21₁ serves for driving the switches 21₁, 21′₁ of the first one of the parallel-connected converters, while a second S21₂ serves for driving the switches 21₂, 21′₂ of the other one of the parallel-connected converters. The drive signals are generated in temporally offset fashion with respect to one another, such that charging phases of the two forward converters occur in temporally offset fashion (interleaved). The drive signals S21₁, S21₂ can result from a common drive signal which is generated for example in accordance with the explanation concerning FIG. 17 and which is output by the drive circuit 60 for example directly as first drive signal S21₁ and in temporally offset fashion as second drive signal S21₂. The generation of drive signals S41₁, S41₂ for freewheeling elements 41₁, 41₂ present on the secondary side is effected in accordance with the explanations concerning FIGS. 16 and 17 using the drive signals S21₁, S21₂ on the primary side. The rectifier elements 46₁, 4₆₂ can be realized as MOSFETs with an integrated body diode in accordance with the explanations concerning FIG. 18.

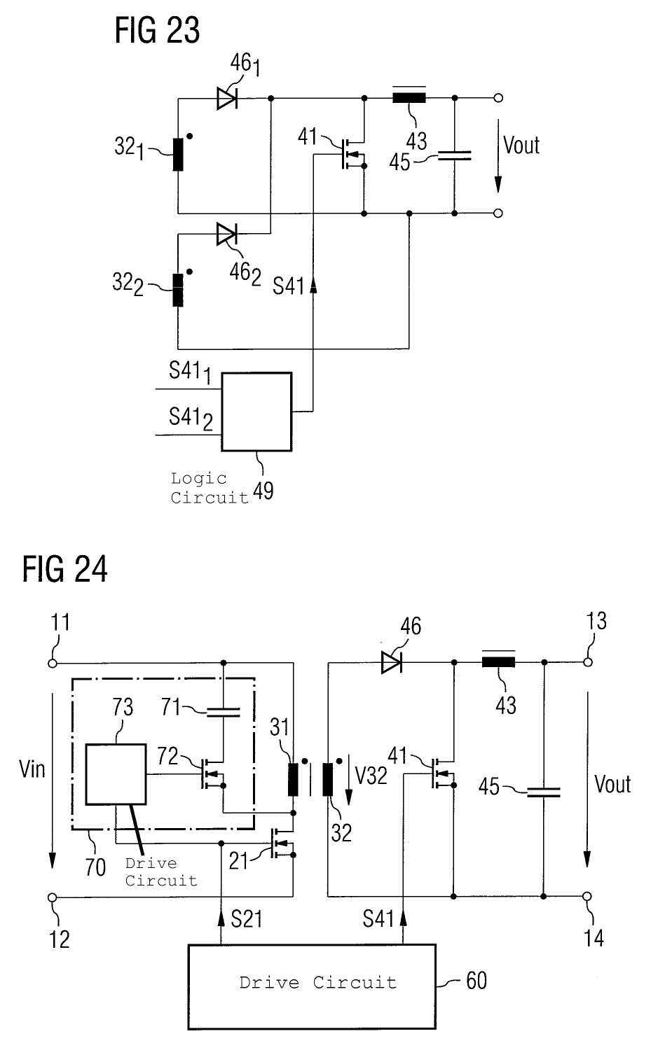

FIG. 23 shows an alternative secondary-side topology for the switching converter in accordance with FIG. 22. In this case, the secondary-side rectifier arrangement has only one storage inductor 43, to which the secondary windings 32₁, 32₂ of the two parallel-connected converters are connected via rectifier elements 46₁, 46₂. Correspondingly, only one freewheeling element 41 is present on the secondary side, the freewheeling element being connected in parallel with the series circuit comprising the storage inductor 43 and the output capacitor 45. A drive signal S41 for the freewheeling element 41 is generated for example by virtue of the fact that, in accordance with the explanations concerning FIGS. 16 and 17, a drive signal S41₁, S41₂ for a secondary-side freewheeling element is generated with respect to each of the primary-side drive signals (S21₁, S21₂ in FIG. 22), and that the drive signal S41 for the single secondary-side freewheeling element 41 is generated from these two drive signals S41₁, S41₂ by means of a logic circuit 49. The logic circuit 49 is in this case realized in such a way that it provides that the freewheeling element 41 is in the conducting state if a current flows through neither of the two secondary-side rectifier elements 46₁, 46₂ or if neither of the two primary-side switches is in the conducting state. FIG. 24 shows a further exemplary embodiment of a single transistor forward converter, which differs from the converter illustrated in FIG. 15 by virtue of the fact that an active clamping circuit 70 is connected in parallel with the primary winding 31. The auxiliary winding illustrated in FIG. 15 can be dispensed with in this case. The active clamping circuit 70 comprises a series circuit comprising a capacitor 71 and a switching element 72, for example a transistor, connected in series with the capacitor 71. When switch 72 of the clamping circuit 70 is closed and when switch 21 connected in series with a primary winding 31 is open, energy from the primary winding 31 can be stored in the capacitor 71 in the case of this circuit. The temporal profiles of the secondary voltage 32 across the secondary winding depending on the primary-side drive signal S21 correspond to the temporal profiles illustrated in FIG. 16 for the switching converter illustrated in FIG. 24. With regard to the generation of this primary-side drive signal S21 and of the drive signal S41 for the secondary-side freewheeling element 41, therefore, reference is made to the explanations concerning FIGS. 16 and 17. In accordance with the explanations according to FIGS. 18 and 20, the secondary-side rectifier element 46 can be replaced by a MOSFET in the switching converter illustrated in FIG. 24.

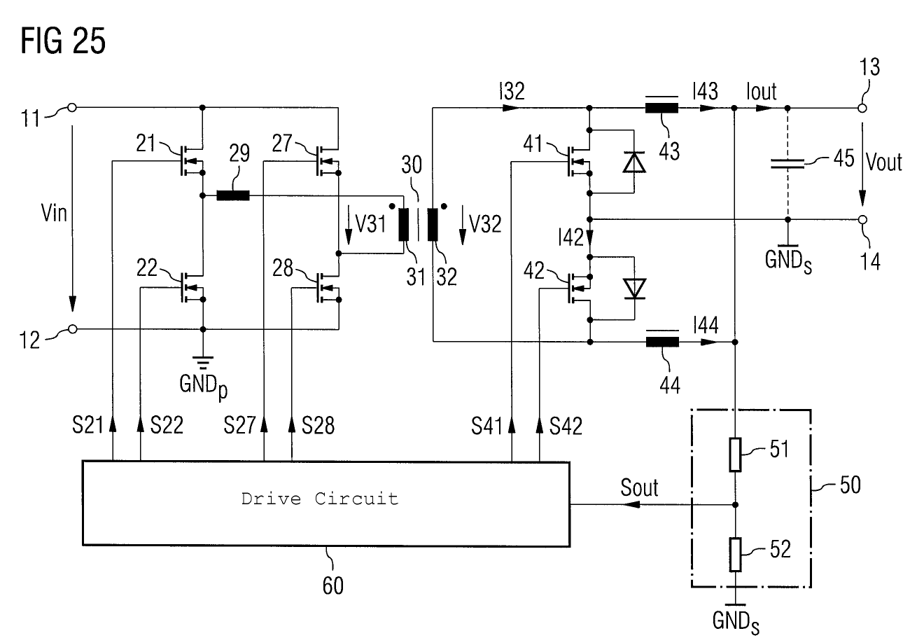

In the switching converter illustrated in FIG. 24, the switch 72 of the clamping circuit 70 is driven depending on the primary-side drive signal by a suitable drive circuit 73 that is known in principle. FIG. 25 shows a switching converter topology that differs from the topology illustrated in FIG. 1 by virtue of the fact that a full-bridge circuit is present on the primary side, the full-bridge circuit having two further switches 27, 28 in addition to the switches 21, 22 already explained with reference to FIG. 1. In the circuit illustrated in FIG. 25, these further switches 27, 28 are connected in series with one another between the input terminals 11, 12 instead of the capacitors (23, 24 in FIG. 1). In this case, one connection of the primary winding 31 is connected to a center tap of these two further switches 27, 28. The individual switches 21, 22 and 27, 28 of the half-bridge are driven in a manner that is known in principle by application of a positive and a negative voltage to the primary winding 31 in each case in phase-shifted fashion. Voltage profiles of the primary voltage V31 and of the secondary voltage V32 in this case correspond to the voltage profiles explained with reference to FIG. 2. The explanations concerning FIG. 2 correspondingly hold true for the signal profiles of the current doubler circuit present on the secondary side. For applying a positive voltage to the primary winding 31, the first and fourth switches 21, 28 of the full-bridge are driven in the conducting state in the case of the switching converter illustrated in FIG. 25. This operating phase corresponds to the operating phase I in accordance with FIG. 2. During a subsequent freewheeling phase corresponding to the operating phase II in accordance with FIG. 2, the first and third switches 21, 27 of the half-bridge are driven in the conducting state in order thereby to enable a freewheeling current for the primary winding 31. For applying a negative voltage to the primary winding 31, the second and third switches 22, 27 of the half-bridge are driven in the conducting state. This operating phase corresponds to the operating phase III in accordance with FIG. 2. During a subsequent freewheeling phase corresponding to the operating phase IV in accordance with FIG. 2, the second and fourth switches 22, 28 of the full-bridge are driven in the conducting state in order thereby to enable a freewheeling current of the primary winding. In the case of this switching converter illustrated in FIG. 25, a coil 29 can be connected in series with the primary winding 31 between the tapping points of the full-bridge. The coil 29 enables the switching converter to be operated in such a way that the individual switches of the full-bridge are in each case switched on when a voltage drop across the switches is zero (zero voltage switching, ZVS).

A generation of the drive signals S21, S22, S27, S28 for the phase-shifted driving of the individual switches of the full-bridge with the aim of controlling the output voltage Vout to a desired value is known, in principle, such that this is not discussed in any greater detail. In this case, the time periods during the transition from the freewheeling phases to the charging phases, that is to say the time durations before the first and fourth switches 21, 28, and respectively the second and third switches 22, 27 are simultaneously driven in the conducting state, are in each case critical with regard to an occurrence of overvoltage spikes at the secondary-side freewheeling elements 41, 42. A delay time between the simultaneous conducting driving of the switches and the turn-off of the freewheeling elements is set adaptively in this switching converter in accordance with the explanations concerning FIGS. 1 to 7.

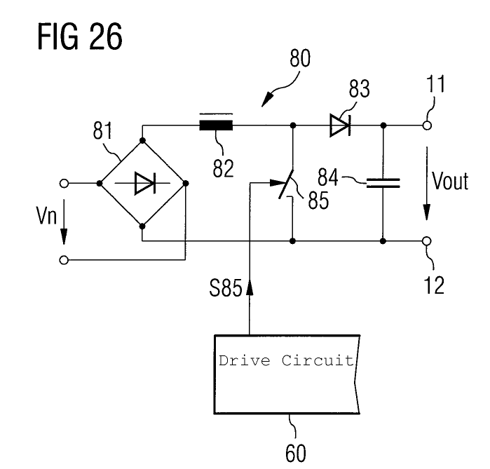

The input voltage Vin of the switching converters explained above can be generated from a mains supply voltage Vn for example by a power factor correction circuit (Power Factor Controller, PFC). Referring to FIG. 26, such a power factor controller comprises for example an input bridge rectifier 81, to which the mains supply voltage Vn is fed, and a step-up converter connected downstream of the bridge rectifier and comprising a series circuit formed by a storage inductor 82, a rectifier element 83 and an output capacitor 84. In this case, a switch 85 for controlling a power consumption of the storage inductor 82 is connected in parallel with the series circuit comprising the rectifier element 83 and the output capacitor 84. The construction and functioning of such a power factor controller are known, in principle, such that no further explanations are necessary in this respect. A drive signal S85 for driving the switch 85 depending on the input voltage Vin is generated for example likewise by the drive circuit 60, which also generates the drive signals for the switching converters explained above. The drive circuit 60 with the transfer circuit 64 can be embodied for example as a single integrated circuit. When using a coreless transformer as transfer circuit, the coils of the coreless transformer can be realized as planar coils on the semiconductor chip or in the semiconductor chip. Driver circuits for the primary-side switches of the switching converters are not illustrated in the figures explained above - with the exception of FIG. 1. The driver circuits serve on the one hand for converting the drive signals generated by the drive circuit 60 to suitable signal levels. Moreover, the driver circuits can also realize protection functions for the primary-side semiconductor switches in a manner not illustrated in more specific detail. The protection functions may comprise for example a protection of the semiconductor switches against over-temperature, overvoltage or overcurrent. For example, so-called SMART-FETs, which already have such an integrated protection function, can be provided as primary-side semiconductor switches.

In the exemplary embodiments explained above, a time delay Td2 between the beginning of a conducting driving of the secondary-side rectifier elements and the turn-off of the primary-side switches is positive, that is to say that the beginning of the conducting driving of the secondary-side rectifier elements temporally succeeds a blocking driving of the primary-side switches. If the secondary-side rectifier elements used are MOSFETs which have a significantly higher current-carrying capacity than MOSFETs used as switches on the primary side, and which therefore have a correspondingly high gate capacitance, then the delay time can also be negative. In this case, a conducting driving of the secondary-side rectifier elements temporally precedes a blocking driving of the primary-side switches. On account of the high gate capacitance and the associated long charging duration of the gate capacitance until the secondary-side switches are in the conducting state, it may be nevertheless provided in this case that the primary-side and secondary-side MOSFETs are not simultaneously in the conducting state.

It was assumed for the explanation above that the drive signals for the primary-side switches are generated on the secondary side and transferred. In all the exemplary embodiments explained, the primary-side switches and the rectifier elements present on the secondary side are driven in a predetermined order during a drive cycle. In a manner not illustrated in more specific detail, therefore, there is the possibility of generating the drive signals for the primary-side switches by means of a primary-side drive circuit and the drive signals for the secondary-side rectifier elements by means of a secondary-side drive circuit and in this case of transferring to the primary-side drive circuit information about the duty cycle of the primary-side drive signals and/or the temporal position of the switched-on durations within a drive cycle.

1-15. (canceled)

16. An apparatus, comprising:
a transformer comprising a first winding and a second winding;
a first switch coupled to the first winding and configured to alternate between an off state and an on state in response to a pulsed first signal;
a rectifier coupled to the second winding and configured to alternate between an off state and an on state in response to a pulsed second signal; and
a drive circuit configured to generate the first and second signals such that the first switch and the rectifier are switched to the on state in a temporally offset relation with each other.

17. The apparatus of claim 16, wherein the drive circuit is further configured to dynamically change an amount of the temporal offset.

18. The apparatus of claim 16, wherein the drive circuit is configured to set an amount of the temporal offset depending upon a voltage at the rectifier.

19. The apparatus of claim 16, wherein the drive circuit is configured to set an amount of the temporal offset depending upon a peak voltage at the rectifier.

20. The apparatus of claim 16, wherein the drive circuit is configured to set an amount of the temporal offset depending upon a temperature of at least a portion of the rectifier.

21. The apparatus of claim 16, wherein the drive circuit is configured to set an amount of the temporal offset depending upon a measured efficiency of the apparatus.

22. The apparatus of claim 16, wherein the rectifier comprises an inductive storage element and a capacitive storage element in series with each other, and a rectification element coupled in parallel with the inductive storage element and the capacitive storage element.

23. The apparatus of claim 16, wherein the rectifier comprises a storage inductor and a rectification element, wherein the rectification element is coupled between the second winding and the storage inductor.

24. The apparatus of claim 16, wherein the drive circuit is further configured to generate a pulsed third signal, the apparatus further comprising a second switch coupled to the first winding a second switch coupled to the first winding and configured to alternate between an off state and an on state in response to the third signal.

25. The apparatus of claim 24, wherein the third signal has a same duty cycle as a duty cycle of the first signal.

26. The apparatus of claim 24, wherein the third signal has a duty cycle that is different from a duty cycle of the first signal.

27. A method, comprising:
alternating a first switch between an off state and an on state, the first switch being coupled to a first winding of a transformer;
receiving by a rectifier a second signal from a second winding of the transformer; and
alternating the rectifier between an off state and an on state such that the first switch and the rectifier are switched to the on state in a temporally offset relation with each other.

28. The method of claim 27, wherein alternating the first switch and alternating the rectifier comprise alternating the first switch and the rectifier such that at most only one of the first switch and the rectifier are in the on state at any given time.

29. The method of claim 27, wherein alternating the first switch and alternating the rectifier comprise alternating the first switch and the rectifier such that the rectifier is changed to an on state only after a time delay after the first switch is most recently changed to an off state.

30. The method of claim 27, further comprising changing an amount of the temporal offset.

31. The method of claim 27, further comprising setting an amount of the temporal offset depending upon a voltage at the rectifier.

32. The method of claim 27, further comprising setting an amount of the temporal offset depending upon a peak voltage at the rectifier.

33. The method of claim 27, further comprising setting an amount of the temporal offset depending upon a temperature of at least a portion of the rectifier.

34. The method of claim 27, setting an amount of the temporal offset depending upon a measured efficiency.

35. An apparatus, comprising:
a transformer comprising a first winding and a second winding;
switching means coupled to the first winding and configured to alternate between an off state and an on state in response to a pulsed first signal;
rectification means coupled to the second winding and configured to alternate between an off state and an on state in response to a pulsed second signal; and
means for generating the first and second signals such that the first switch and the rectification means are switched to the on state in a temporally offset relation with each other.

36. An apparatus, comprising:
a transformer comprising a first winding and a second winding;
a first switch coupled to the first winding and configured to temporarily switch to an on state in response to a pulse from a first signal;
a rectifier coupled to the second winding and configured to temporarily switch to an on state in response to a pulse from a second signal; and
a drive circuit configured to generate the first and second signals such that the second signal is pulsed after a delay following completion of a most recent pulse of the first signal.

37. The apparatus of claim 36, wherein the drive circuit is further configured to set an amount of the delay depending upon a voltage at the rectifier.

38. The apparatus of claim 36, wherein the drive circuit is further configured to set an amount of the delay depending upon a peak voltage at the rectifier.

39. The apparatus of claim 36, further comprising a second switch coupled to the first winding a second switch coupled to the first winding and configured to temporarily switch to an on state in response to a pulse from a third signal,
wherein the drive circuit is further configured to generate the third signal such that the third signal us pulsed after a delay following completion of a most recent pulse of the second signal.
